(19) United States
(12) Patent Application Publication
(10) Pub. No.: US 2025/0080668 A1
(43) Pub. Date: Mar. 6, 2025

(54) IMAGE PROCESSING APPARATUS, IMAGE PROCESSING SYSTEM, AND IMAGE PROCESSING METHOD

(71) Applicant: PFU LIMITED, Kahoku-shi (JP)

(72) Inventors: Yasunaga Kawasaki, Kahoku-shi (JP); Yasutaka Maeda, Kahoku-shi (JP)

(21) Appl. No.: 18/808,922

(22) Filed: Aug. 19, 2024

(30) Foreign Application Priority Data
Aug. 28, 2023 (JP) 2023-138250

(51) Int. Cl. H04N 1/00

(52) U.S. Cl. CPC H04N 1/00482; H04N 2201/0094

(57) ABSTRACT

An image processing apparatus includes circuitry to acquire a plurality of input images by imaging media, execute image processing on a specific number of input images among the plurality of input images, and output, when a degree of unnecessariness or redundancy of the image processing for the specific number of input images meets a predetermined criterion, a recommendation to omit the image processing or change an imaging method for a medium.

### CROSS-REFERENCE TO RELATED APPLICATIONS

This patent application is based on and claims priority pursuant to 35 U.S.C. § 119 (a) to Japanese Patent Application No. 2023-138250, filed on Aug. 28, 2023, in the Japan Patent Office, the entire disclosure of which is hereby incorporated by reference herein.

### BACKGROUND

The present disclosure relates to an image processing apparatus, an image processing system, and an image processing method.

Currently, image processing apparatuses that process images acquired by imaging media have been used in various applications. In such an image processing apparatus, image processing such as the detection of various information including characters and barcodes is required to be executed to appropriately manage the various information.

A known image processing apparatus performs inclination correction on a read document image when the read document image is not a blank image and does not perform the inclination correction on a read document image when the read document image is a blank image.

### SUMMARY

According to an embodiment, an image processing apparatus includes circuitry to acquire a plurality of input images by imaging media, execute image processing on a specific number of input images among the plurality of input images, and output, when a degree of unnecessariness or redundancy of the image processing for the specific number of input images meets a predetermined criterion, a recommendation to omit the image processing or change an imaging method for a medium.

According to an embodiment, an image processing system includes an image reading apparatus including first circuitry and an information processing apparatus including second circuitry. The first circuitry and the second circuitry operate in cooperation to acquire a plurality of input images by imaging media, execute image processing on a specific number of input images among the plurality of input images, output, when a degree of unnecessariness or redundancy of the image processing for the specific number of input images meets a predetermined criterion, a recommendation to omit the image processing or change an imaging method for a medium.

According to an embodiment, an image processing method includes acquiring a plurality of input images by imaging media, executing image processing on a specific number of input images among the plurality of input images, and outputting, when a degree of unnecessariness or redundancy of the image processing for the specific number of input images meets a predetermined criterion, a recommendation to omit the image processing or change an imaging method for a medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image processing system according to an embodiment;

FIG. 2 is a perspective view of an image reading apparatus according to an embodiment;

FIG. 3 is a diagram illustrating a conveyance passage inside an image reading apparatus according to an embodiment;

FIG. 4 is a schematic block diagram illustrating a configuration of an image reading apparatus according to an embodiment;

FIG. 5 is a schematic block diagram illustrating a configuration of a first storage device and a first processing circuit according to an embodiment;

FIG. 6 is a schematic block diagram illustrating a configuration of an information processing apparatus according to an embodiment;

FIG. 7 is a flowchart illustrating an example of an image reading process according to an embodiment;

FIG. 8 is a flowchart illustrating an example of an image reading process according to an embodiment, following the flowchart of FIG. 7;

FIG. 9 is a schematic diagram illustrating an example of a recommendation screen represented by display data according to an embodiment;

FIG. 10 is a flowchart illustrating an example of an image reading process according to another embodiment;

FIGS. 11A and 11B are a flowchart illustrating an example of post-processing according to an embodiment;

FIG. 12 is a flowchart illustrating an example of post-processing according to another embodiment;

FIG. 13 is a schematic block diagram illustrating a configuration of a first processing circuit according to another embodiment;

FIG. 14 is a schematic block diagram illustrating a configuration of a second storage device and a second processing circuit according to another embodiment; and

FIG. 15 is a schematic block diagram illustrating a configuration of a second processing circuit according to another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image processing apparatus, an image processing system, an image processing method, and a control program according to aspects of the present disclosure are described below with reference to the drawings. The technical scope of the present disclosure is not limited to the embodiments described herein and encompasses the scope of the appended claims and the equivalents thereof. Therefore, numerous additional modifications and variations are possible based on the teachings provided herein.

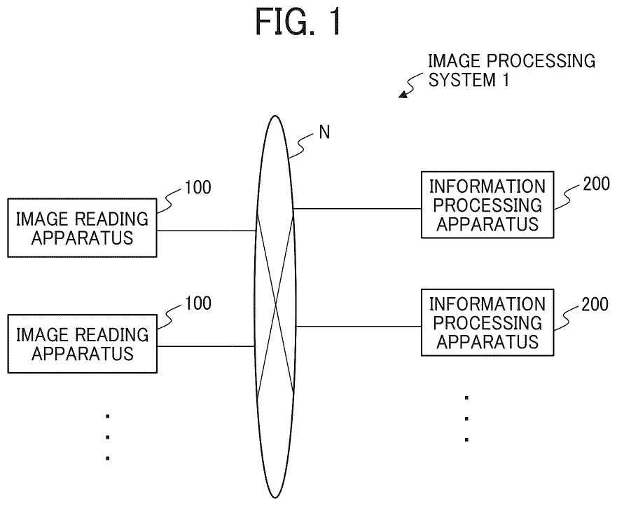

FIG. 1 is a schematic diagram illustrating a configuration of an image processing system according to an embodiment.

As illustrated in FIG. 1, an image processing system 1 includes one or more image reading apparatuses 100 and one or more information processing apparatuses 200. The image reading apparatus 100 and the information processing apparatus 200 are communicably connected to each other through a network N. Examples of the network N include the Internet and an intranet. Each of the image reading apparatus 100 and the information processing apparatus 200 is an example of an image processing apparatus.

For example, the image reading apparatus 100 is an automatic document feeder (ADF) scanner that images a medium such as a document while conveying the medium. Examples of media include sheets of plain paper, sheets of thin paper, sheets of thick paper, and cards. Examples of media further include various types of media such as receipts, business cards, invoices, and delivery notes. The image reading apparatus 100 may be such as a facsimile machine, a copier, or a multifunction peripheral (MFP). The image reading apparatus 100 may be a flatbed type apparatus that images a medium without conveying the medium.

Examples of the information processing apparatus 200 include a personal computer, a laptop personal computer, a tablet computer, and a smartphone. The information processing apparatus 200 may be a server that resides on a cloud network.

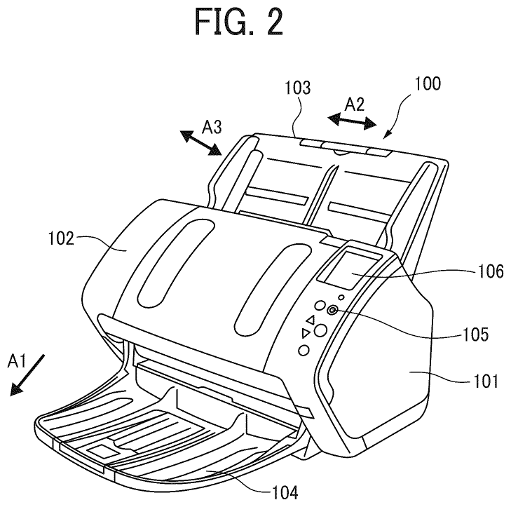

FIG. 2 is a perspective view of an image reading apparatus according to an embodiment.

The image reading apparatus 100 includes a lower housing 101, an upper housing 102, a media tray 103, an ejection tray 104, a first input device 105, and a first display device 106.

The upper housing 102 is located to cover the upper face of the image reading apparatus 100 and engaged with the lower housing 101 with a hinge such that the upper housing 102 can be opened and closed for removing a jammed medium or cleaning the inside of the image reading apparatus 100.

The media tray 103 is engaged with the lower housing 101 such that media to be conveyed can be placed on the media tray 103. The ejection tray 104 is engaged with the lower housing 101 such that media ejected from the ejection port can be held on the ejection tray 104.

The first input device 105 includes an input device such as buttons and an interface circuit that acquires signals from the input device. The first input device 105 receives an input operation performed by a user and outputs an operation signal corresponding to the input operation. The first display device 106 includes a display and an interface circuit that outputs image data to the display. The first display device 106 displays the image data on the display. Examples of the display include a liquid crystal display and an organic electro-luminescence (EL) display.

In FIG. 2, Arrow A1 indicates the direction in which a medium is conveyed and may be referred to as a “media conveyance direction A1” in the following description. Arrow A2 indicates the width direction perpendicular to the media conveyance direction and may be referred to as a “width direction A2” in the following description. Arrow A3 indicates the height direction perpendicular to the media conveyance direction and the width direction. In the following description, the term “upstream” refers to upstream in the media conveyance direction A1, and the term “downstream” refers to downstream in the media conveyance direction A1.

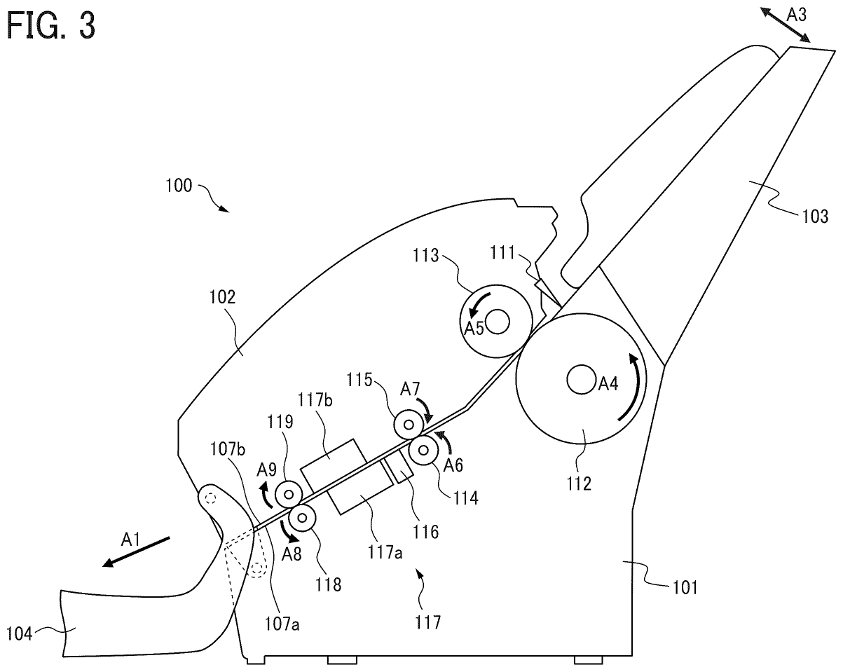

FIG. 3 is a diagram illustrating a conveyance passage inside an image reading apparatus according to an embodiment.

The image reading apparatus 100 includes, along the conveyance passage, a first media sensor 111, a feed roller 112, a separation roller 113, a first conveyance roller 114, a second conveyance roller 115, a second media sensor 116, an imaging device 117, a third conveyance roller 118, and a fourth conveyance roller 119. The number of each of the above rollers is not limited to one and may be multiple. When one or more of the above rollers are formed of multiple rollers, the multiple rollers are arranged at intervals in the width direction A2. The feed roller 112, the separation roller 113, the first conveyance roller 114, the second conveyance roller 115, the third conveyance roller 118, and the fourth conveyance roller 119 are collectively an example of a conveyor, and sequentially convey media.

The image reading apparatus 100 includes a so-called straight path. The upper face of the lower housing 101 forms a lower guide 107a for the media conveyance passage. The lower face of the upper housing 102 forms an upper guide 107b for the media conveyance passage.

The first media sensor 111 is located upstream from the feed roller 112 and the separation roller 113. The first media sensor 111 includes a contact detection sensor and detects whether a medium is placed on the media tray 103. The first media sensor 111 generates and outputs a first media signal whose signal value changes depending on whether a medium is placed on the media tray 103. The first media sensor 111 is not limited to the contact detection sensor. The first media sensor 111 may be any other sensor that can detect the presence of a medium. Examples of any other sensor include an optical detection sensor.

The feed roller 112 is in the lower housing 101 and sequentially feeds media on the media tray 103 from the bottom. The separation roller 113 is a so-called brake roller or retard roller. The separation roller 113 is located in the upper housing 102, facing the feed roller 112. The feed roller 112 and the separation roller 113 function as a separator that separates media. Instead of the separation roller 113, a separation pad may be used.

The first conveyance roller 114 and the second conveyance roller 115 are located downstream from the feed roller 112 and the separation roller 113 and face each other. The first conveyance roller 114 and the second conveyance roller 115 convey a medium fed by the feed roller 112 and the separation roller 113 to the imaging device 117.

The second media sensor 116 is located downstream from the first conveyance roller 114 and the second conveyance roller 115 and upstream from the imaging device 117. The second media sensor 116 detects a medium conveyed to the position of the second media sensor 116. The second media sensor 116 includes a light emitter, a light receiver, and a light guide. The light emitter and the light receiver are located on one side of the media conveyance passage (e.g., the lower housing 101 side). The light guide is located facing the light emitter and the light receiver with the media conveyance passage in between (e.g., the upper housing 102 side). The light emitter is, for example, a light emitting diode (LED) and emits light toward the media conveyance passage. The light receiver is, for example, a photodiode and receives the light that is emitted by the light emitter and guided by the light guide. When a medium is present at a position facing the second media sensor 116, the light emitted from the light emitter is blocked by the medium, and the light receiver does not detect the light emitted from the light emitter. The light receiver generates and outputs a second media signal based on the intensity of the light received. The second media signal changes in signal value depending on whether a medium is present at the position of the second media sensor 116. The number of second media sensors 116 may be multiple. When the number of second media sensors 116 is multiple, the second media sensors 116 are arranged at intervals in the width direction A2.

Instead of the light guide, a reflector such as a mirror may be used. The light emitter and the light receiver may be located facing each other with the media conveyance passage in between. Further, the second media sensor 116 may detect the presence of a medium using a contact sensor that causes a predetermined current to flow when the medium is in contact with the contact sensor or when no medium is in contact with the contact sensor.

The imaging device 117 is an example of an image sensor. The imaging device 117 is located downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are located near the media conveyance passage and face each other with the media conveyance passage in between.

The first imaging device 117a includes a light source and a line sensor based on a unity-magnification optical system type contact image sensor (CIS) including complementary metal oxide semiconductor- (CMOS-) based imaging elements linearly aligned in a main scanning direction. The first imaging device 117a further includes lenses each forming an image on an imaging element, and an analog-to-digital (A/D) converter amplifying and A/D converting an electric signal output from the imaging element. The first imaging device 117a generates an input image by imaging the front side of a medium conveyed by the conveyor and outputs the input image, that is, generates input images by sequentially imaging the front sides of media sequentially conveyed by the conveyor and outputs the input images.

Similarly, the second imaging device 117b includes a light source and a line sensor based on a unity-magnification optical system type CIS including CMOS-based imaging elements linearly aligned in a main scanning direction. The second imaging device 117b further includes lenses each forming an image on an imaging element, and an A/D converter amplifying and A/D converting an electric signal output from the imaging element. The second imaging device 117b generates an input image by imaging the back side of a medium conveyed by the conveyor and outputs the input image, that is, generates input images by sequentially imaging the back sides of media sequentially conveyed by the conveyor and outputs the input images.

The image reading apparatus 100 may include either the first imaging device 117a or the second imaging device 117b to read only one side of the medium. Instead of the CIS line sensor, which employs an equal-magnification optical system and includes CMOSs as imaging elements, a CIS line sensor that employs an equal-magnification optical system and includes charge-coupled devices (CCDs) as imaging elements may be used. Alternatively, a line sensor employing a reduction optical system and including CMOSs or CCDs as imaging elements may be used.

The third conveyance roller 118 and the fourth conveyance roller 119 are located downstream from the imaging device 117 and face each other. The third conveyance roller 118 and the fourth conveyance roller 119 eject a medium conveyed by the first conveyance roller 114 and the second conveyance roller 115 onto the ejection tray 104.

A medium placed on the media tray 103 is conveyed between the lower guide 107a and the upper guide 107b in the media conveyance direction A1 by the feed roller 112 rotating in the direction indicated by Arrow A4 in FIG. 3. The separation roller 113 rotates or stops in the direction of Arrow A5 in FIG. 3 when conveying a medium. When multiple media are placed on the media tray 103, a medium in contact with the feed roller 112 is separated from the rest of the media on the media tray 103 due to the action of the feed roller 112 and separation roller 113. This prevents the multiple feeding, that is, the feeding of a medium other than the separated medium.

The medium is fed between the first conveyance roller 114 and the second conveyance roller 115 while being guided by the lower guide 107a and the upper guide 107b. As the first conveyance roller 114 rotates in the direction of Arrow A6 in FIG. 3 and the second conveyance roller 115 rotates in the direction of Arrow A7 in FIG. 3, the medium is fed between the first imaging device 117a and the second imaging device 117b. As the third conveyance roller 118 rotates in the direction of Arrow A8 in FIG. 3 and the fourth conveyance roller 119 rotates in the direction of Arrow A9 in FIG. 3, the medium read by the imaging device 117 is ejected to the ejection tray 104.

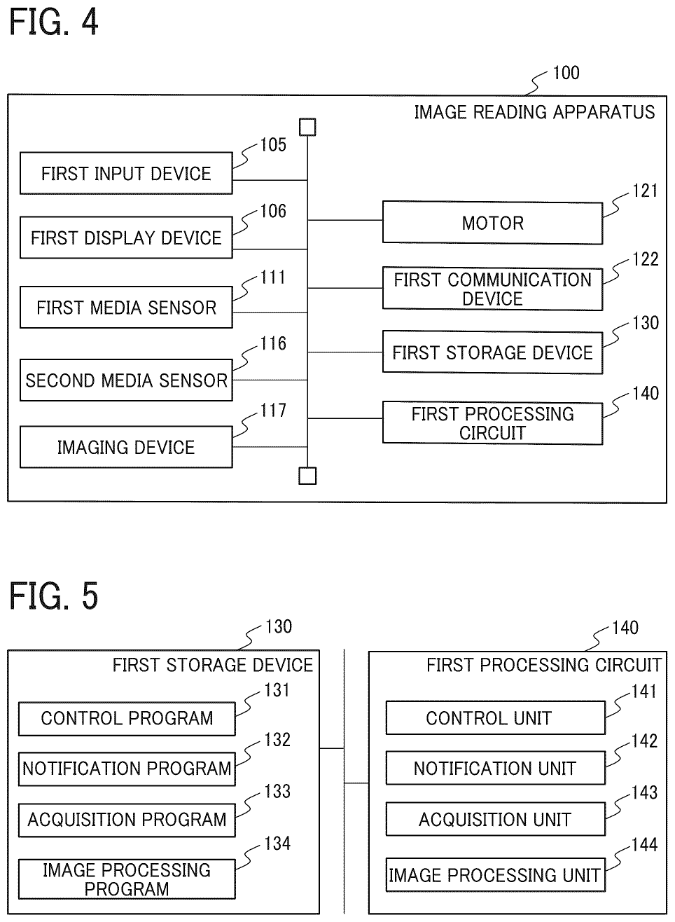

FIG. 4 is a schematic block diagram illustrating a configuration of an image reading apparatus according to an embodiment.

In addition to the configuration described above, the image reading apparatus 100 includes a motor 121, a first communication device 122, a first storage device 130, and a first processing circuit 140.

The motor 121 includes one or multiple motors. The motor 121 rotates the feed roller 112, the separation roller 113, the first conveyance roller 114, the second conveyance roller 115, the third conveyance roller 118, and the fourth conveyance roller 119 according to a control signal from the first processing circuit 140 to convey a medium. One of the first conveyance roller 114 and the second conveyance roller 115 may be a driven roller that rotates according to the rotation of the other one. One of the third conveyance roller 118 and the fourth conveyance roller 119 may be a driven roller that rotates according to the rotation of the other one.

The first communication device 122 includes an antenna and a wireless communication interface circuit. The antenna transmits and receives wireless signals. The wireless communication interface circuit transmits and receives signals through a wireless communication line according to a communication protocol such as a wireless local area network (LAN) protocol. The first communication device 122 communicates with the information processing apparatus 200. The first communication device 122 transmits and receives various images and information to and from the information processing apparatus 200 according to an instruction from the first processing circuit 140. The first communication device 122 may include a wired communication interface circuit according to a communication protocol such as the Transmission Control Protocol/Internet Protocol (TCP/IP) and may be connected to the information processing apparatus 200 through a network. The first communication device 122 may include an interface circuit compatible with a serial bus such as a universal serial bus (USB) and may be connected to the information processing apparatus 200 through a wired cable such as a USB cable.

The first storage device 130 is an example of a memory. The first storage device 130 includes a random-access memory (RAM), a read-only memory (ROM), a fixed disk device such as a hard disk, and a portable storage device such as a flexible disk or an optical disc. The first storage device 130 stores computer programs, databases, tables, etc. used for various processes performed by the image reading apparatus 100. The computer programs may be installed in the first storage device 130 from a computer-readable portable recording medium using a known setup program. The portable recording medium includes a compact disc-read-only memory (CD-ROM) and a digital versatile disc-read-only memory (DVD-ROM). The computer programs may be distributed from a server and installed in the first storage device 130.

The first processing circuit 140 operates according to a program pre-stored in the first storage device 130. The first processing circuit 140 is, for example, a central processing unit (CPU). Alternatively, a digital signal processor (DSP), a large scale integration (LSI), an application-specific integrated circuit (ASIC), or a field-programmable gate array (FPGA) may be used as the first processing circuit 140.

The first processing circuit 140 is connected to the first input device 105, the first display device 106, the first media sensor 111, the second media sensor 116, the imaging device 117, the motor 121, the first communication device 122, and the first storage device 130 and controls these components. The first processing circuit 140 performs drive control of the motor 121 and imaging control of the imaging device 117 and acquires an input image. The first processing circuit 140 performs image processing on the acquired input image and calculates the degree of unnecessariness or redundancy of the image processing. When the calculated degree meets a predetermined criterion, the first processing circuit 140 outputs a recommendation to omit the image processing or change the imaging method for a medium to the first communication device 122 or the first display device 106 to notify the user of the recommendation.

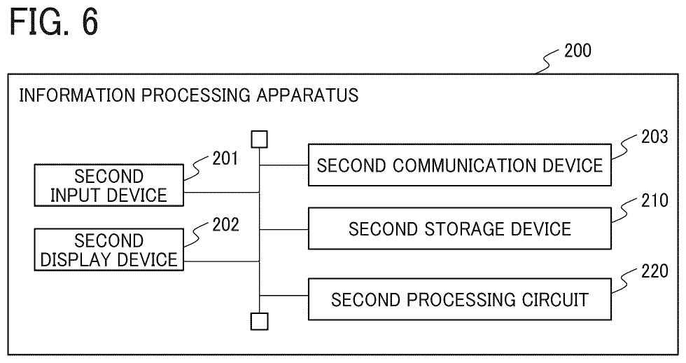

FIG. 5 is a schematic block diagram illustrating a configuration of a first storage device and a first processing circuit according to an embodiment.

As illustrated in FIG. 5, the first storage device 130 stores a control program 131, a notification program 132, an acquisition program 133, and an image processing program 134. These programs are functional modules implemented by software operating on a processor. The first processing circuit 140 reads the programs stored in the first storage device 130 and operates according to the read programs, thereby functioning as a control unit 141, a notification unit 142, an acquisition unit 143, and an image processing unit 144.

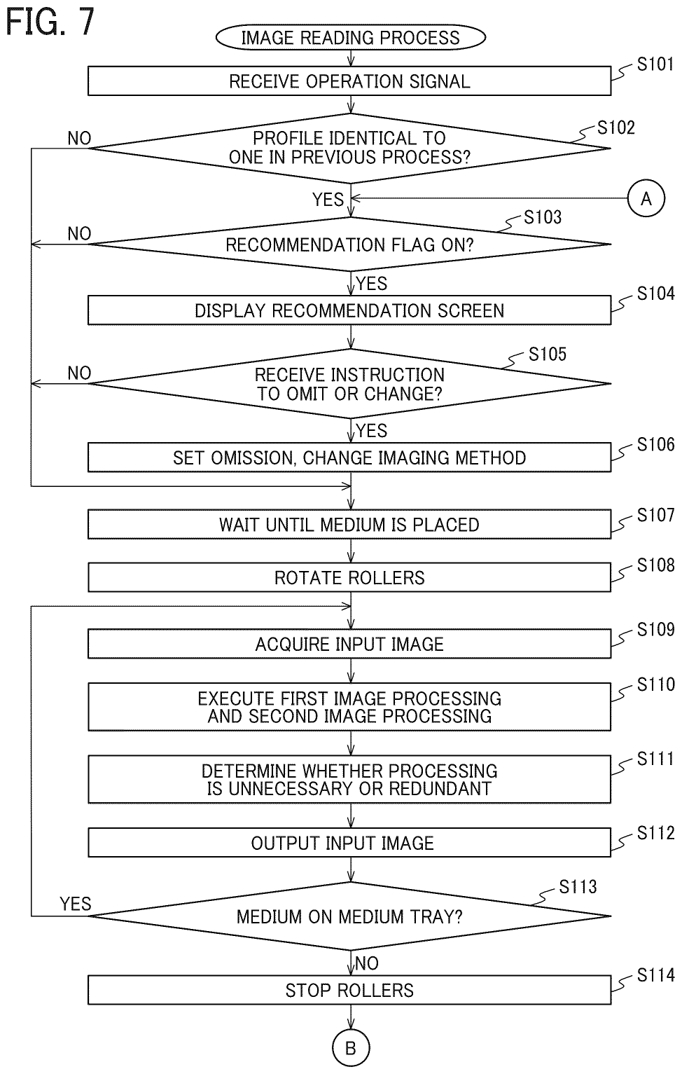

FIG. 6 is a schematic block diagram illustrating a configuration of an image reading apparatus according to an embodiment.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device. The second input device 201 outputs a signal corresponding to an operation performed by a user to the second processing circuit 220.

The second display device 202 includes a display and an interface circuit that outputs image data to the display. The second display device 202 displays various information on the display according to an instruction from the second processing circuit 220. Examples of the display include a liquid crystal display and organic EL display.

The second communication device 203 includes an antenna that transmits and receives wireless signals, and a wireless communication interface circuit that transmits and receives signals through a wireless communication line according to a predetermined communication protocol such as a wireless LAN protocol. The second communication device 203 can communicate with the image reading apparatus 100. The second communication device 203 transmits and receives various images and information to and from the image reading apparatus 100 according to an instruction from the second processing circuit 220. The second communication device 203 may include a wired communication interface circuit according to a communication protocol such as the TCP/IP and may be connected to the image reading apparatus 100 through a network. The first communication device 122 may include an interface circuit compatible with a serial bus such as a USB and may be connected to the image reading apparatus 100 through a wired cable such as a USB cable.

The second storage device 210 is an example of a memory. The second storage device 210 includes a RAM, ROM, a fixed disk device such as a hard disk, and a portable storage device such as a flexible disk or an optical disc. The second storage device 210 stores computer programs, databases, tables, etc. used for various processes performed by the information processing apparatus 200. The computer programs may be installed in the second storage device 210 from a computer-readable portable recording medium such as a CD-ROM or a DVD-ROM using a known setup program. The computer programs may be distributed from a server and installed in the second storage device 210.

The second processing circuit 220 operates according to a program pre-stored in the second storage device 210. The second processing circuit 220 is, for example, a CPU. Alternatively, a DSP, an LSI, an ASIC, or an FPGA may be used as the second processing circuit 220.

The second processing circuit 220 is connected to the second input device 201, the second display device 202, the second communication device 203, the second storage device 210, etc. and controls these components. The second processing circuit 220 controls the data transmission and reception with the image reading apparatus 100 via the second communication device 203, the input from the second input device 201, the display of the second display device 202, etc.

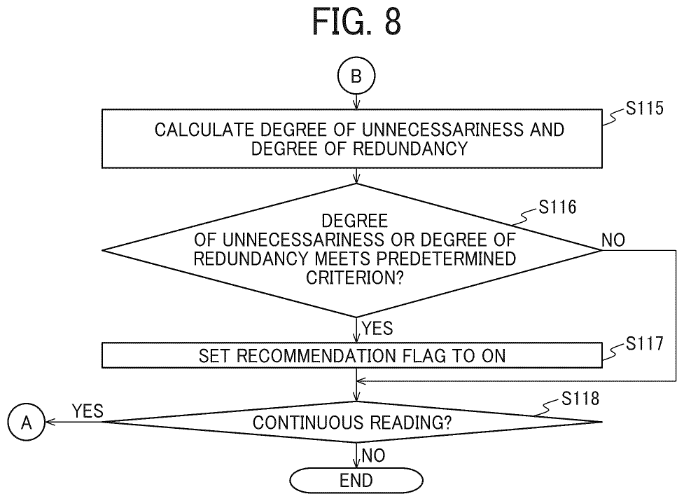

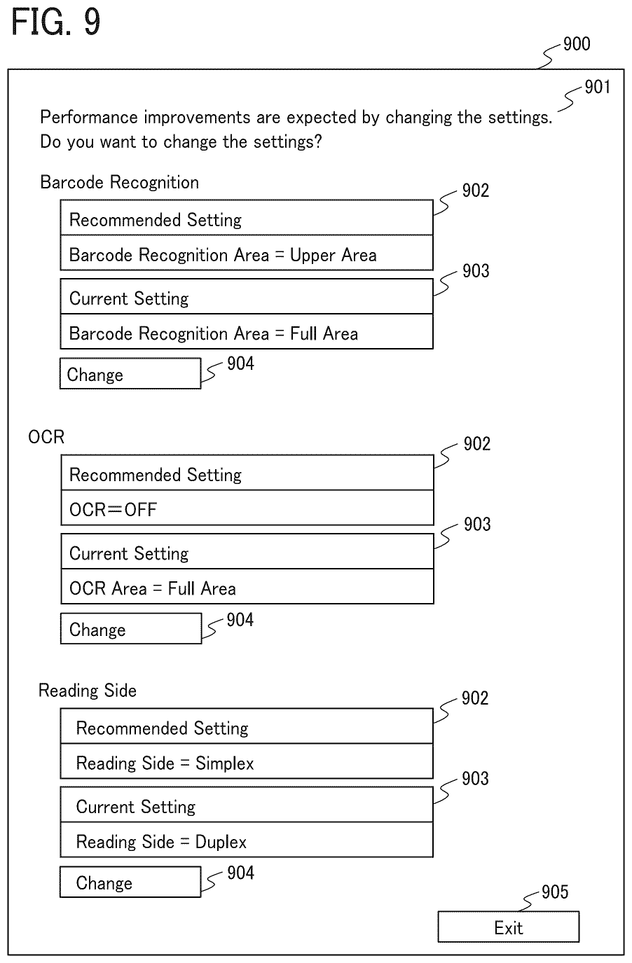

FIGS. 7 and 8 are flowcharts illustrating an image reading process according to an embodiment.

Referring to FIGS. 7 and 8, an image reading process performed by an image reading apparatus according to an embodiment is described below. The flow of steps described below is executed by, for example, the first processing circuit 140 in cooperation with one or more of the components of the image reading apparatus 100 according to the program pre-stored in the first storage device 130.

The control unit 141 receives an operation signal indicating an instruction to read media from the first input device 105 or the first communication device 122 (Step S101). The operation signal is output when the user input the instruction using the first input device 105 or the information processing apparatus 200. The operation signal includes a profile specified by the user using the first input device 105 or the information processing apparatus 200 along with the instruction to read media. The profile is settings set by the user for imaging processing, first image processing, or second image processing according to, for example, the usage of an image to be generated or the type of media to be imaged.

The settings for imaging processing define an imaging method for a medium and include a resolution setting and a reading side setting. With the resolution setting, the resolution of an input image can be set to a setting value such as 150 dots per inch (dpi), 200 dpi, 300 dpi, 600 dpi, or 1200 dpi. The image reading apparatus 100 can generate an input image with the set resolution by configuring settings including the media conveyance speed, the imaging timing (time interval) by the imaging device 117, and the position of the imaging element in the line sensor to be used in the imaging processing. With the reading side setting, a side of a medium to be imaged can be set to simplex (single-sided) or duplex (double-sided).

The first image processing is an example of image processing that may be unnecessary or redundant for a part of input images. The first image processing includes image processing operations such as color determination, orientation correction, blank sheet detection, barcode recognition, and optical character recognition (OCR). In the following description, the first image processing may be referred to as a first image processing operation when the first image processing indicates one of the image processing operations above. The color determination is an image processing operation of determining whether the color components included in an input image are color, grayscale, or binary and converting the tone values of the pixels in the input image into values corresponding to the determined color components. The orientation correction is an image processing operation of rotating an input image to make the orientation of the medium included in the input image to be correct (upward). The blank sheet detection is an image processing operation of determining whether a blank sheet is included in an input image and deleting the input image including the blank sheet if there is any. The barcode recognition is an image processing operation of detecting a barcode from an input image. The OCR is an image processing operation of performing character recognition on an input image. When the barcode recognition or the OCR is specified to be executed in the profile, an area such as the full area, an upper area, a middle area, or a lower area in an input image is also specified for the execution of the barcode recognition or the OCR in the profile.

On the other hand, the second image processing is different from the first image processing and is to be executed on all input images. The second image processing includes image processing operations such as cropping and color adjustment. In the following description, the second image processing may be referred to as a second image processing operation when the second image processing indicates one of the image processing operations above. The cropping is an image processing operation of cropping an area including the image of a medium from an input image. The color adjustment is an image processing operation of adjusting colors in an input image.

In the profile, one or more settings for imaging processing are configured to generate an input image and/or one or more first image processing operations (settings for first image processing) or second image processing operations (settings for second image processing) to be executed on an input image are specified. The control unit 141 stores (configures) the settings for imaging processing, the first image processing, and the second image processing, which are specified in the profile, in the first storage device 130. The profile further includes a setting for continuous reading. The setting for continuous reading is for continuously reading one or more media newly placed on the media tray 103 by the user, following the completion of the reading of all the media placed on the media tray 103.

Subsequently, the notification unit 142 determines whether the profile specified in the current image reading process is identical to the profile specified in the previous image reading process (Step S102). When the profile specified in the current image reading process is not identical to the profile specified in the previous image reading process, the notification unit 142 proceeds to Step S107 without executing any particular processing.

On the other hand, when the profile specified in the current image reading process is identical to the profile specified in the previous image reading process, the notification unit 142 determines whether a recommendation flag is ON (Step S103). The recommendation flag is set for each first image processing operation that is specifiable in the profile. Further, the recommendation flag is set for each setting for imaging processing that is specifiable in the profile. The initial value of each recommendation flag is OFF. When the omission of the first image processing is recommended or the change of the imaging method for a medium, that is, the change of the settings for imaging processing is recommended, the corresponding recommendation flag is set to ON in a process described later. When the recommendation flag is OFF for the first image processing (each of all the first image processing operations) that is specified to be executed in the profile of the current image reading process, the notification unit 142 proceeds to Step S107 without executing any particular processing.

On the other hand, when the recommendation flag is ON for the first image processing (at least one of all the first image processing operations) that is specified to be executed in the profile of the current image reading process, the notification unit 142 generates display data of a recommendation screen. The notification unit 142 outputs the display data of the recommendation screen by displaying the recommendation screen on the first display device 106 or transmitting the display data to the information processing apparatus 200 via the first communication device 122 (Step S104). When receiving the display data from the image reading apparatus 100 via the second communication device 203, the information processing apparatus 200 displays the recommendation screen represented by the received display data on the second display device 202. The notification unit 142 further sets the recommendation flag to OFF.

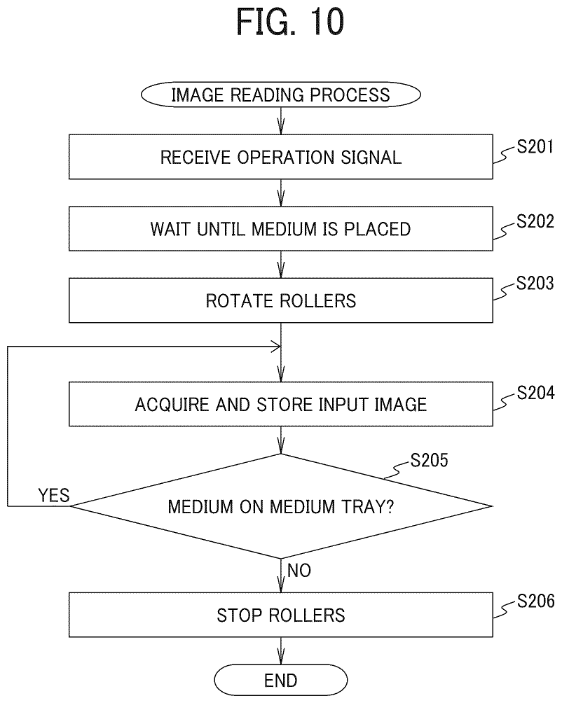

FIG. 9 is a schematic diagram illustrating an example of a recommendation screen represented by display data according to an embodiment.

As illustrated in FIG. 9, a recommendation screen 900 includes a text message 901, a recommended setting 902, a current setting 903, a change button 904, and an end button 905. The text message 901 is a character string indicating a recommendation to omit the first image processing or change the imaging method for a medium. The recommended setting 902, the current setting 903, and the change button 904 are displayed for each first image processing operation that is recommended to be omitted or for each setting that is recommended to be changed for the imaging processing. The recommendation to omit the first image processing also includes a recommendation to omit a part of the first image processing, that is, to change the settings for the first image processing. The recommended setting 902 indicates a setting recommended for each first image processing operation or the imaging processing. The current setting 903 indicates a setting currently configured for each first image processing operation or the imaging processing. The change button 904 is a button for changing the current setting to the recommended setting for each first image processing operation or the imaging processing. The end button 905 is a button for ending the display of the recommendation screen 900.

Referring again to FIG. 7, the notification unit 142 determines whether an instruction to omit the first image processing or change the imaging method for a medium has been received (Step S105). The notification unit 142 receives an instruction to omit the first image processing or change the imaging method for a medium when the end button 905 is pressed after one or more of the change buttons 904 are pressed on the recommendation screen 900 by the user using the first input device 105 or the information processing apparatus 200. The pressed change button 904 corresponds to one of the first image processing operations or one of the settings for imaging processing. The notification unit 142 receives an instruction signal corresponding to the pressed change button 904 from the first input device 105 or the first communication device 122 and receives an instruction to omit the first image processing or change the imaging method for a medium accordingly. On the other hand, when the end button 905 is pressed without any of the change buttons 904 being pressed on the recommendation screen 900, the notification unit 142 receives an instruction to end the display of the recommendation screen 900. The notification unit 142 receives an end instruction signal from the first input device 105 or the first communication device 122 and receives an end instruction to end the display of the recommendation screen 900 accordingly.

When receiving the end instruction to end the display of the recommendation screen 900, the notification unit 142 ends the display of the recommendation screen 900 and proceeds to Step S107. When the recommendation screen 900 is displayed on the information processing apparatus 200, the notification unit 142 transmits a request signal requesting to end the display of the recommendation screen 900 to the information processing apparatus 200 via the first communication device 122. When receiving the request signal from the image reading apparatus 100 via the second communication device 203, the information processing apparatus 200 ends the display of the recommendation screen 900.

When receiving the instruction to omit the first image processing or change the imaging method for a medium, the notification unit 142 ends the display of the recommendation screen 900. The notification unit 142 further sets to omit the first image processing specified by the instruction signal or change a setting for the imaging processing, that is, change the imaging method for a medium specified by the instruction signal (Step S106). To omit the first image processing includes omitting one or more of the first image processing operations and changing a setting for a first image processing operation. In other words, to omit the first image processing can be said to change the settings for the first image processing. The notification unit 142 changes the setting for the first image processing or the setting for the imaging processing specified by the instruction signal in the first image processing operations or the settings for imaging processing stored (configured) in the first storage device 130 to the recommended setting 902 displayed on the recommendation screen 900.

Subsequently, the control unit 141 waits until a medium is placed on the media tray 103 (Step S107). The control unit 141 acquires a first media signal from the first media sensor 111 and determines whether a medium is placed on the media tray 103 based on the acquired first media signal.

Subsequently, the control unit 141 drives the motor 121 to rotate the feed roller 112, the separation roller 113, the first conveyance roller 114, the second conveyance roller 115, the third conveyance roller 118, and/or the fourth conveyance roller 119 (Step S108). Thus, the control unit 141 feeds and conveys the medium from the media tray 103. The control unit 141 rotates the motor 121 at a speed that allows the generation of an input image according to the profile acquired in Step S101, in particular, an input image with the resolution specified in the profile. When a setting for the imaging processing is changed in Step S106, the control unit 141 controls the motor 121 so that an input image is generated according to the changed setting.

Subsequently, the acquisition unit 143 acquires the input image in which the conveyed medium is imaged from the imaging device 117 (Step S109).

For example, the acquisition unit 143 determines whether the leading end of the medium has passed the position of the second media sensor 116 based on the second media signal received from the second media sensor 116. The acquisition unit 143 acquires the second media signals periodically from the second media sensor 116 and determines that the leading end of the medium has passed the position of the second media sensor 116 when the signal values of the second media signals change from indicating the absence of a medium to indicating the presence of a medium. The acquisition unit 143 controls the imaging device 117 to start imaging when the leading end of the medium has passed the position of the second media sensor 116. The control unit 141 controls the imaging device 117 to generate an input image according to the profile acquired in Step S101. When a setting for the imaging processing is changed in Step S106, the control unit 141 controls the imaging device 117 so that an input image is generated according to the changed setting.

Then, the acquisition unit 143 causes the imaging device 117 to end imaging when the trailing end of the medium has passed through the imaging position of the imaging device 117. For example, the acquisition unit 143 determines whether the trailing end of the medium has passed the position of the second media sensor 116 based on the second media signals received from the second media sensor 116. The acquisition unit 143 acquires the second media signals periodically from the second media sensor 116 and determines that the trailing end of the medium has passed the position of the second media sensor 116 when the signal values of the second media signal changes from indicating the presence of a medium to indicating the absence of a medium. The acquisition unit 143 determines that the trailing end of the medium has passed the imaging position of the imaging device 117 when a predetermined time period has elapsed after the trailing end of the medium passes the position of the second media sensor 116. The predetermined time period is set to a time taken for a medium to move from the second media sensor 116 to the imaging position.

The acquisition unit 143 acquires predetermined lines of an input image from the imaging device 117 each time the imaging device 117 generates the predetermined lines of the input image and combines the acquired lines of the input image to acquire the input image when the imaging device 117 ends imaging. The acquisition unit 143 may acquire collectively all the lines of an input image at a time when the imaging device 117 ends the imaging.

Subsequently, the image processing unit 144 executes the first image processing and the second image processing on the input image (Step S110). The image processing unit 144 starts executing the second image processing before starting executing the first image processing, that is, the second image processing is executed in priority to the first image processing. The image processing unit 144 executes the first image processing and the second image processing according to the profile acquired in Step S101. When the omission of the first image processing is set in Step S106, the image processing unit 144 executes the first image processing (first image processing operations) for which the omission is not set in Step S106. In other words, the image processing unit 144 does not execute a first image processing operation determined to be unnecessary and a part of a first image processing operation determined to be redundant in the first image processing operations for which the instruction to omit is received.

When color determination is specified as a first image processing operation to be executed, the image processing unit 144 determines whether the color components included in an input image are color or black and white based on the distribution of the color values (such as the R value, G value, or B value) of the pixels in the input image. The image processing unit 144 calculates the variance of the color values for each pixel in the input image. When the average value of the calculated variances is equal to or greater than a predetermined color variance threshold, the image processing unit 144 determines that the color components included in the input image are color. When the average value of the calculated variances is less than the color variance threshold, the image processing unit 144 determines that the color components included in the input image are black and white. When the color components are determined to be black and white, the image processing unit 144 determines whether the color components included in the input image is grayscale or binary based on the distribution of the luminance values of the pixels in the input image. The image processing unit 144 calculates the variance of the luminance values of the pixels in the input image. When the calculated variance is equal to or greater than a predetermined luminance variance threshold, the image processing unit 144 determines that the color components included in the input image are grayscale. When the calculated variance is less than the luminance variance threshold, the determination unit 145 determines that the color components included in the input image is binary. The image processing unit 144 converts the tone values of the pixels in the input image so that the input image includes the identified color components.

When the orientation correction is specified as a first image processing operation to be executed, the image processing unit 144 executes OCR while rotating an input image by 90 degrees using a known image processing technique such as rotation processing. The image processing unit 144 determines that the orientation of the medium included in the input image is correct (upward) when the largest number of characters is detected in the input image and rotates the input image so that the orientation of the medium is correct.

When the blank sheet detection is specified as a first image processing operation to be executed, the image processing unit 144 extracts an edge pixel of which the gradation value (e.g., luminance value or color values) differs from that of the adjacent pixels by a tone threshold or greater in the input image. The image processing unit 144 detects the largest area among areas surrounded by the edge pixels adjacent to each other as a medium area. The image processing unit 144 determines whether the input image includes a blank sheet based on whether the number of edge pixels included in the detected medium area is equal to or less than a predetermined threshold. When determining that the input image includes a blank sheet, the image processing unit 144 deletes the input image.

When the barcode recognition is specified as a first image processing operation to be executed, the image processing unit 144 determines whether an image includes a barcode using a discriminator pre-trained to output whether an image includes a barcode when the image is input. For example, the discriminator is pre-trained by deep learning with multiple images including various barcodes and pre-stored in the first storage device 130. The image processing unit 144 inputs an area specified for the execution of the barcode recognition in the input image to the discriminator and identifies whether the specified area includes a barcode based on information output from the discriminator.

When the OCR is specified as a first image processing operation to be executed, the image processing unit 144 executes character recognition on an area specified for the execution of the OCR in an input image using a known OCR technique.

When the cropping is specified as a second image processing operation to be executed, the image processing unit 144 detects a medium area in an input image and crop the detected medium area from the input image in substantially the same manner as in the case of the blank sheet detection.

When the color adjustment is specified as a second image processing operation to be executed, the image processing unit 144 executes color adjustment by executing gamma correction or applying a predetermined filter such as a smoothing filter or an edge enhancement filter to an input image.

The notification unit 142 may output the execution result of the first image processing by displaying the execution result on the first display device 106 or transmitting the execution result to the information processing apparatus 200 via the first communication device 122 to notify the user of the execution result each time the first image processing is executed. In this case, the notification unit 142 outputs the total number of input images acquired up to the present time, the number of input images for each identified color component, the number of input images for each rotated angle in the orientation correction, the number of input images including blank sheets, the number of input images with barcodes detected for each specifiable area, the number of input images with characters detected for each specifiable area, etc. This allows the user to recognize the feature of each medium in real-time.

Subsequently, the image processing unit 144 determines whether the executed first image processing is unnecessary or redundant and stores the determination result in the first storage device 130 (Step S111).

For the color determination, when the color components of the input image are color, the image processing unit 144 determines that converting the tone value of each pixel in the input image is not necessary and determines that the first image processing is not necessary. When the color components of almost all of the media collectively placed on the media tray 103 are either grayscale or binary, there is a case where the tone value of each pixel in the input image may be fixedly converted into grayscale or binary without determining the color components included in the input images. Accordingly, when the number of input images including the color components in grayscale or binary is equal to or greater than a predetermined proportion of the input images, the image processing unit 144 determines that determining the color components included in an input image is not necessary and determines that the first image processing (first image processing operation) is redundant.

For the orientation correction, when the orientation of a medium is correct without rotating the input image, the image processing unit 144 determines that correcting the orientation of the medium is not necessary and determines that the first image processing (first image processing operation) is not necessary. Further, when almost all of the media collectively placed on the media tray 103 are rotated by the same angle to correct the orientation of the media, the input images may be rotated by a fixed angle without detecting the orientation of the medium. Accordingly, when the number of input images rotated by the same angle is equal to or greater than a predetermined proportion of the input images, the image processing unit 144 determines that detecting the orientation of a medium is not necessary and determines that the first image processing (first image processing operation) is redundant.

For the blank sheet detection, when the input images of almost all of the media collectively placed on the media tray 103 do not include a blank sheet, an input image including a blank sheet may not be deleted. Accordingly, when the number of input images including no blank sheet is equal to or greater than a predetermined proportion of the input images, the image processing unit 144 determines that deleting an input image including a blank sheet is not necessary and determines that the first image processing (first image processing operation) is not necessary. Further, when almost all of the media collectively placed on the media tray 103 have one side blank, an input image including a blank sheet may not have to be deleted by imaging only one side of a medium but not imaging both sides of the medium. Accordingly, when the number of media having one side blank is equal to or greater a predetermined proportion of the media, the image processing unit 144 determines that deleting an input image including a blank sheet is redundant and determines that the first image processing (first image processing operation) is redundant.

For the barcode recognition, when a barcode is not detected in an input image, the image processing unit 144 determines that the barcode recognition is not necessary and determines that the first image processing (first image processing operation) is not necessary. Further, when a barcode is in only an area smaller than a specified area, which is specified from among the areas that are specifiable in an input image, executing the detection for a barcode on only the area smaller than the specified area is sufficient. Accordingly, the image processing unit 144 determines that the first image processing (first image processing operation) is redundant when a barcode is detected only in an area smaller than a specified area among the areas that are specifiable in an input image.

For the OCR, when the number of characters detected in an input image is less than a predetermined number, the image processing unit 144 determines that the OCR is not necessary and determines that the first image processing (first image processing operation) is not necessary. The predetermined number is set to any number equal to or greater than 1. Further, when a character to be detected is in only an area smaller than a specified area, which is specified from among the areas that are specifiable in an input image, executing the detection for a character on only the area smaller than the specified area is sufficient. Accordingly, the image processing unit 144 determines that the first image processing (first image processing operation) is redundant when one or more characters are detected only in an area smaller than a specified area in an input image and the number of detected characters is equal to or grater than a predetermined number.

Further, for the OCR, when only characters of a large size are present, or when the density of characters (the number of characters per predetermined area) is small, the resolution of the input image may be low. Accordingly, when only characters of a predetermined size or more are present and the resolution is a predetermined resolution or more, the image processing unit 144 determines that the OCR for the input image with high resolution is redundant and determines that the first image processing (first image processing operation) is redundant. Further, when the density of characters is equal to or less than a predetermined density and the resolution is equal to or greater than the predetermined resolution, the image processing unit 144 determines that the OCR for the input image with high resolution is redundant and determines that the first image processing (first image processing operation) is redundant.

By contrast, the cropping and the color adjustment are to be performed on each of the media. Accordingly, for the cropping and the color adjustment, the image processing unit 144 determines that the first image processing is not unnecessary or redundant.

Subsequently, the image processing unit 144 outputs the input image on which the first image processing and the second image processing have been executed by transmitting the input image to the information processing apparatus 200 via the first communication device 122 (Step S112). When receiving the input image from the image reading apparatus 100 via the second communication device 203, the information processing apparatus 200 causes the second display device 202 to display the received input image.

Subsequently, the control unit 141 determines whether a medium remains on the media tray 103 based on the first media signal received from the first media sensor 111 (Step S113). When a medium remains on the media tray 103, the control unit 141 returns to Step S109 and repeats the processing of Steps S109 to S113.

Accordingly, the acquisition unit 143 acquires a specific number of input images by imaging a specific number of media that are collectively placed on the media tray 103 and sequentially conveyed and imaged in the image reading apparatus 100. Then, the image processing unit 144 executes the first image processing and the second image processing on the specific number of input images. The media collectively placed on the media tray 103 are highly likely to be the same type, and the input images obtained by imaging the media one by one are highly likely to have the same feature. By using such the input images acquired by imaging the media collectively placed on the media tray 103, the image reading apparatus 100 can determine whether the first image processing is unnecessary or redundant with high accuracy.

By contrast, when no medium remains on the media tray 103, the control unit 141 stops the motor 121 to stop the feed roller 112, the separation roller 113, the first conveyance roller 114, the second conveyance roller 115, the third conveyance roller 118, and the fourth conveyance roller 119 (Step S114). Thus, the control unit 141 stops media conveyance.

Subsequently, the image processing unit 144 calculates the degree of unnecessariness and the degree of redundancy of the first image processing for the specific number of input images on which the first image processing has been executed (Step S115). The image processing unit 144 calculates the degree of unnecessariness and the degree of redundancy for each first image processing operations specifiable in the profile.

For the color determination, the image processing unit 144 calculates the proportion of the number of input images whose color components are color in the number (specific number) of input images on which the first image processing has been executed as the degree of unnecessariness. The image processing unit 144 calculates the degree of redundancy using the lager one of the number of input images whose color components are grayscale and the number of input images whose color components are binary, in the number (specific number) of input images on which the first image processing has been executed. More specifically, when the lager one is the number of input image whose color components are grayscale, the image processing unit 144 calculates the proportion of the number of input image whose color components are grayscale in the number (specific number) of input images on which the first image processing has been executed as the degree of redundancy. When the larger one is the number of input images whose color components are binary, the image processing unit 144 calculates the proportion of the number of input image whose color components are binary in the number (specific number) of input images on which the first image processing has been executed as the degree of redundancy.

For the orientation correction, the image processing unit 144 calculates the proportion of the number of input images in which the orientations of media are correct without rotating the input images in the number (specific number) of input images on which the first image processing has been executed as the degree of unnecessariness. Further, the image processing unit 144 classifies the input images on which the first image processing has been executed for each angle at which the input images are rotated to correct the orientations of media. The image processing unit 144 further identifies the largest number of input images rotated by the same angle. The notification unit 142 calculates the proportion of the identified largest number in the number of input images (specific number) on which the first image processing has been executed as the degree of redundancy.

For the blank sheet detection, the image processing unit 144 calculates the proportion of the number of input images including no blank sheet in the number (specific number) of input images on which the first image processing has been executed as the degree of unnecessariness. The image processing unit 144 calculates the proportion of the number of input images in each which one side (specific side) of the medium is blank in the number (specific number) of input images on which the first image processing has been executed as the degree of unnecessariness.

For the barcode recognition, the image processing unit 144 calculates the proportion of the number of input images in which a barcode is not detected in the number (specific number) of input images on which the first image processing has been executed as the degree of unnecessariness. Further, the image processing unit 144 counts, for each area specifiable by the user, the number of input images in which a barcode is not detected in an area other than the area specified by the user. The image processing unit 144 identifies an area for which the number of counted input images is the maximum as a first target area and calculates the proportion of the number of input images counted for the first target area in the number (specific number) of input images on which the first image processing has been executed as the degree of redundancy.

For the OCR, the image processing unit 144 calculates the proportion of the number of input images in which a predetermined number or more of characters are not detected in the number (specific number) of input images on which the first image processing has been executed as the degree of unnecessariness. Further, the image processing unit 144 counts, for each area specifiable by the user, the number of input images in which a predetermined number or more of characters are not detected in an area other than the area specified by the user. The image processing unit 144 identifies an area for which the number of counted input images is the maximum as a second target area. The image processing unit 144 further calculates the proportion of the number of input images counted for the second target area in the number (specific number) of input images on which the first image processing has been executed as the degree of redundancy.

The image processing unit 144 identifies the number of input images in which only characters having a predetermined size or more are present and the resolution is equal to or greater than a predetermined resolution. Alternatively, the image processing unit 144 identifies the number of input images in which the density of characters is equal to or less than a predetermined density and the resolution is equal to or greater than the predetermined resolution. The image processing unit 144 calculates the proportion of the number of identified input images in the number (specific number) of input images on which the first image processing has been executed as the redundancy degree for the OCR for input images with high resolution.

The notification unit 142 may calculate a value by multiplying each of the above proportions by a predetermined coefficient, as the degree of unnecessariness or the degree of redundancy. Alternatively, the notification unit 142 may calculate a value by adding or subtracting a predetermined offset to or from each of the above proportions, as the degree of unnecessariness or the degree of redundancy.

The image processing unit 144 may calculate the degree of unnecessariness or the degree of redundancy based on feature information of input images instead of an execution result of the first image processing. In other words, the image processing unit 144 may calculate the degree of unnecessariness or the degree of redundancy based on feature information of input images regardless of whether the first image processing has been executed on the input images.

In this case, for the color determination, the image processing unit 144 detects the color components included in the input images as the feature information. For the orientation correction, the image processing unit 144 detects the orientations of the media included in the input images as the feature information. For the blank sheet detection, the image processing unit 144 detects whether a blank sheet is included in the input images as the feature information.

For the barcode recognition and the OCR, the image processing unit 144 extracts an edge pixel for each specified area. The extraction may be performed in substantially the same manner as in the case of the blank sheet detection. The image processing unit 144 determines whether an object is in each area based on whether the number of edge pixels included in each area is equal to or greater than a predetermined threshold and detects information indicating whether an object is in each area as the feature information. The image processing unit 144 determines that the first image processing (first image processing operation) is not necessary when no object is in the input images and determines that the first image processing (first image processing operation) is redundant when an object is only in an area smaller than the specified area among the areas that are specifiable in the input images. The image processing unit 144 calculates the proportions of the number of input images in each of which no object is present in the number (specific number) of input images on which the first image processing has been executed as the degree of unnecessariness. Further, the image processing unit 144 counts, for each area specifiable by the user, the number of input images in which an object is absent in an area other than the area specified by the user to obtain the maximum number of input images. The image processing unit 144 identifies, as a target area, an area for which the number of counted input images is the maximum. The image processing unit 144 further calculates the proportion of the number of input images counted for the target area in the number (specific number) of input images on which the first image processing has been executed as the degree of redundancy.

As described above, the image processing unit 144 can facilitate the calculation of the degree of unnecessariness or the degree of redundancy.

Subsequently, the image processing unit 144 determines whether the degree of unnecessariness or the degree of redundancy meets a predetermined criterion (Step S116). The image processing unit 144 determines whether the degree of unnecessariness or the degree of redundancy meets a predetermined criterion for each first image processing operation specifiable in the profile.

For example, the image processing unit 144 determines that the degree of unnecessariness meets the predetermined criterion when the degree of unnecessariness is equal to or greater than a threshold of unnecessariness and determines that the degree of unnecessariness does not meet the predetermined criterion when the degree of unnecessariness is less than the threshold of unnecessariness. The threshold of unnecessariness is pre-set to any value that is greater than 0 and equal to or less than 1. In a case where the threshold of unnecessariness is set to 1, the notification unit 142 determines that the degree of unnecessariness meets the predetermined criterion when the first image processing is determined to be unnecessary for all input images (specific number of input images). A different value may be set to the threshold of unnecessariness for each first image processing operation.

Further, for example, the image processing unit 144 determines that the degree of redundancy meets the predetermined criterion when the degree of redundancy is equal to or greater than a threshold of redundancy and determines that the degree of redundancy does not meet the predetermined criterion when the degree of redundancy is less than the threshold of redundancy. The threshold of redundancy is pre-set to any value that is greater than 0 and equal to or less than 1. In a case where the threshold of redundancy is set to 1, the image processing unit 144 determines that the degree of redundancy meets the predetermined criterion when the first image processing is determined to be redundant for all input images (specific number of input images). A different value may be set to the threshold of redundancy for each first image processing operation.

When the degree of unnecessariness and the degree of redundancy do not meet the predetermined criteria for all the first image processing operations, the notification unit 142 proceeds to Step S118 without executing any particular processing.

On the other hand, when the degree of unnecessariness or the degree of redundancy meets the predetermined criterion for one or more of the first image processing operations, the image processing unit 144 sets the corresponding recommendation flags to ON (Step S117). As described above, when the image reading process using the same profile as the previous image reading process is executed, the notification unit 142 outputs the display data of the recommendation screen in Step S104 to notify the user of the recommendation to omit the first image processing or change the imaging method for a medium. In other words, when a medium is newly read without changing the settings for the imaging processing, the first image processing, or the second image processing after the specific number of input images are generated in the image reading apparatus 100, the notification unit 142 notifies the user of the recommendation to omit the first image processing or change the imaging method for a medium.

When the image reading process is executed using the same profile, the media to be imaged are highly likely to have the same type. Accordingly, the first image processing that is unnecessary or redundant for the media previously imaged is highly likely to be unnecessary or redundant for the media to be imaged. When the degree of unnecessariness or the degree of redundancy meets the predetermined criterion, the image reading apparatus 100 notifies the user of the recommendation to omit the first image processing or change the imaging method for a medium. This allows the user to determine whether to execute the image processing operation related to the recommendation with the current settings. The image processing operation related to the recommendation may be referred to as a notified image processing operation in the following description. When the notified image processing operation is required to be executed with the current settings, the settings does not have to be changed. When the notified image processing operation is unnecessary or redundant, the settings for the processing can be appropriately changed according to a user operation, resulting in the reduction of the processing time of the image reading process. Thus, the image reading apparatus 100 can enhance user convenience.

When the degree of unnecessariness meets the predetermined criterion for a first image processing operation, the notification unit 142 configures the display data of the recommendation screen so that the recommended setting for the first image processing operation indicates “OFF”.

When the degree of redundancy for the color determination meets the predetermined criterion, the notification unit 142 sets the recommended setting in the display data of the recommendation screen to indicate that the tone values of the pixels in the input images are recommended to be fixedly converted to have the color components same as the ones included in the largest number of input images among the specific number of input images. When the degree of redundancy for the orientation correction meets the predetermined criterion, the notification unit 142 sets the recommended setting in the display data of the recommendation screen to indicate that the input images are recommended to be fixedly rotate by the same angle as the one by which the largest number of input images among the specific number of input images are rotated. When the degree of redundancy for the blank sheet detection meets the predetermined criterion, the notification unit 142 sets the recommended setting in the display data of the recommendation screen to indicate that the reading side is recommended to be simplex.

When the degree of redundancy for the barcode recognition meets the predetermined criterion, the notification unit 142 sets the recommended setting in the display data of the recommendation screen to indicate that the barcode detection area is recommended to be limited to the first target area. Further, when the redundancy degree for the OCR meets the predetermined criterion, the notification unit 142 sets the recommended setting in the display data of the recommendation screen to indicate that the character recognition area is recommended to be limited to the second target area. In addition, when the degree of redundancy for the OCR for an input image with high resolution meets the predetermined criterion, the notification unit 142 sets the recommended setting in the display data of the recommendation screen to indicate that the resolution is recommended to be less than a predetermined resolution.

Subsequently, the control unit 141 determines whether the setting for continuous reading is enabled in the profile acquired in Step S101 (Step S118). When the setting for continuous reading is enabled, the control unit 141 returns to Step S103 and repeats the processing from Step S103. Accordingly, when the recommendation flag is ON in Step S103, the notification unit 142 outputs the display data of the recommendation screen in Step S104 and notifies the user of the recommendation to omit the first image processing or change the imaging method for a medium. Then, when a medium is newly placed on the media tray 103 by the user, the continuous reading is executed. On the other hand, when the setting for continuous reading is disabled, the control unit 141 ends the process.

When the setting for continuous reading is enabled or when the image reading process is continuously executed using the same profile, the acquisition unit 143 acquires multiple input images according to the same profile. In this case, the image processing unit 144 executes the first image processing on the specific number of input images among the multiple input images acquired by the acquisition unit 143. When the degree of unnecessariness or the degree of redundancy for the specific number of input images on which the first image processing has been executed meets the predetermined criterion, the notification unit 142 notifies the user of a recommendation to omit the first image processing or change the imaging method. This allows the user to determine whether to execute the notified image processing operation with the current settings. When the notified image processing operation is required to be executed with the current settings, the settings does not have to be changed. When the notified image processing operation is unnecessary or redundant, the settings for the processing can be appropriately changed according to a user operation, resulting in the reduction of the processing time of the image reading process. Thus, the image reading apparatus 100 can enhance user convenience.

The image processing unit 144 may calculate one of the degree of unnecessariness and the degree of redundancy in Step S115 and determine whether the one of the degree of unnecessariness and the degree of redundancy meets the predetermined criterion in Step S116. The image processing unit 144 may determine whether the degree of unnecessariness or the degree of redundancy meets the predetermined criterion for at least one of the first image processing operations, but not for each of all the first image processing operations.

The notification unit 142 may notify of the user of the recommendation to omit the first image processing or change the imaging method regardless of whether the continuous reading is executed. In this case, the notification unit 142 may output the display data of the recommendation screen in Step S117.

Further, even when the image reading process is not continuously executed, the notification unit 142 may notify the user of the recommendation to omit the first image processing or change the imaging method for a medium. In this case, the notification unit 142 stores the recommendation flag and the profile in association with each other in the first storage device 130 in Step S117. The processing of Step S102 is omitted, and the notification unit 142 determines whether the recommendation flag associated with the profile specified for the current image reading process is ON in Step S103. When the recommendation flag is ON, the notification unit 142 displays the recommendation screen represented by the display data in Step S104.

As described above in detail, when a specific first image processing operation (first image processing) is unnecessary or redundant for the specific number of input images, the image reading apparatus 100 recommends the user to omit the first image processing operation (first image processing) or change the imaging method for a medium. When the first image processing operation is required to be executed with the current settings, the settings does not have to be changed. When the first image processing operation is unnecessary or redundant, the settings for the processing can be appropriately changed according to a user operation, resulting in the reduction of the processing time of the image reading process. Thus, the image reading apparatus 100 can enhance user convenience.

In particular, when the first image processing is unnecessary or redundant for the media collectively placed on the media tray 103 and a medium is newly placed on the media tray 103 without changing the settings, the image reading apparatus 100 recommends the user to omit the first image processing or change the imaging method for a medium. A medium that is imaged subsequent to another medium without changing the settings is highly likely to have a feature same as the other medium imaged immediately before. Accordingly, the image reading apparatus 100 can omit the unnecessary or redundant processing for the medium to be imaged based on the feature of the other medium imaged immediately before and can further reduce the processing time of the image reading process.

That is, the image reading apparatus 100 recommends the user to omit the image processing or change the imaging method while the media having substantially the same feature are continuously imaged. Thus, the image reading apparatus 100 can appropriately change the settings before the imaging of all the media is completed and can reduce the processing time of the image reading process.

The image reading apparatus 100 can further reduce power consumption by omitting the unnecessary or redundant first image processing. The image reading apparatus 100 can further standardize the quality of the generated input images by omitting the unnecessary or redundant first image processing.

In general, when a reading process for media takes a considerable amount of time, the user hardly recognizes which of imaging processing for the media or image processing subsequent to the imaging processing has a larger influence. When there is unnecessary or redundant image processing (image processing operation), the image reading apparatus 100 recommends the user to omit the image processing (image processing operation). This allows the user to recognize the unnecessary or redundant image processing (image processing operation) and to expand the knowledge of the image processing. As a result, the user can appropriately set the profile, and the image reading apparatus 100 can enhance user convenience.

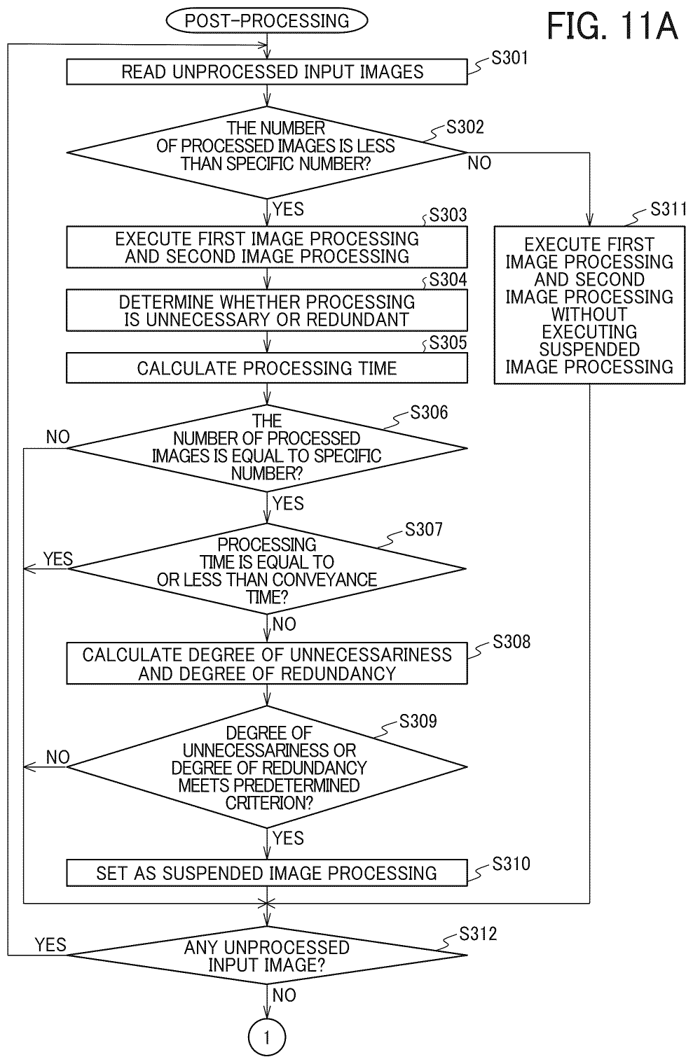

FIG. 10 is a flowchart illustrating an example of an image reading process performed by an image reading apparatus according to another embodiment.

Referring to FIG. 10, the example of an image reading process performed by the image reading apparatus 100 according to the present embodiment is described below. The flow of steps described below is executed by, for example, the first processing circuit 140 in cooperation with one or more of the components of the image reading apparatus 100 according to the program pre-stored in the first storage device 130.

First, the control unit 141 receives an operation signal in substantially the same manner as the processing of Step S101 in FIG. 7 (Step S201).

Subsequently, the control unit 141 waits until a medium is placed on the media tray 103 in substantially the same manner as the processing of Step S107 in FIG. 7 (Step S202).

Subsequently, the control unit 141 rotates the rollers to feed and convey the medium placed on the media tray 103 in substantially the same manner as the processing of Step S108 in FIG. 7 (Step S203).

Subsequently, the control unit 141 acquires an input image from the imaging device 117 and stores the input image in the first storage device 130 in substantially the same manner as the processing of Step S109 in FIG. 7 (Step S204).

Subsequently, the control unit 141 determines whether a medium remains on the media tray 103 in substantially the same manner as the processing of Step S113 in FIG. 7 (Step S205). When a medium remains on the media tray 103, the control unit 141 returns to Step S204 and repeats the processing of Steps S204 and S205. Accordingly, by repeated processing of Step S204, the acquisition unit 143 acquires multiple input images by imaging multiple media.

On the other hand, when no medium remains on the media tray 103, the control unit 141 stops the rollers to stop media conveyance (Step S206) in substantially the same manner as the processing of Step S114 in FIG. 7 and ends the process.

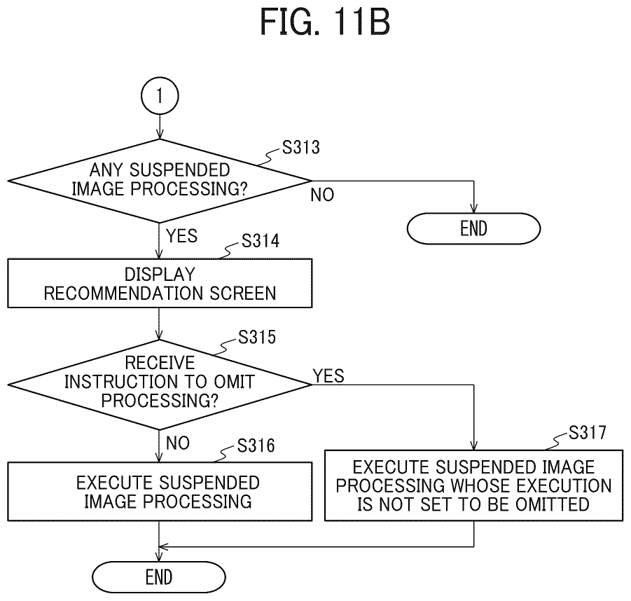

FIGS. 11A and 11B are a flowchart illustrating an example of post-processing performed by the image reading apparatus 100 according to the present embodiment.

Referring to FIGS. 11A and 11B, post-processing performed by the image reading apparatus 100 according to the present embodiment is described below. The flow of steps described below is executed by, for example, the first processing circuit 140 in cooperation with one or more of the components of the image reading apparatus 100 according to the program pre-stored in the first storage device 130. The flowchart illustrated in FIGS. 11A and 11B is performed in parallel with the flowchart illustrated in FIG. 10.

First, the image processing unit 144 reads, from among the input images acquired in Step S204 in FIG. 10, one or more input images on which the second image processing has not been executed, that is, neither the first image processing nor the second image processing has been executed from the first storage device 130 (Step S301). The input image on which neither the first image processing nor the second image processing has been executed may be referred to as an unprocessed input image in the following description.

Subsequently, the image processing unit 144 determines whether the number of input images on which the second image processing has been executed alone or the first image processing and the second image processing have been executed is less than the specific number (Step S302). In the following description, the number of input images on which the second image processing has been executed may be referred to as the number of processed images.

When the number of processed images is less than the specific number, the image processing unit 144 executes the first image processing and the second image processing on the read input images (Step S303). The first image processing and the second image processing are specified to be executed in the profile acquired in Step S201 in FIG. 10. The image processing unit 144 executes the first image processing and the second image processing in substantially the same manner as the processing of Step S110 in FIG. 7. The image processing unit 144 further outputs the input image on which the first image processing and the second image processing have been executed, in substantially the same manner as the processing of Step S112 in FIG. 7. As described above, the image processing unit 144 continuously executes the first image processing and the second image processing on the specific number of input images.

Subsequently, the image processing unit 144 determines whether the executed first image processing is unnecessary or redundant in substantially the same manner as the processing of Step S111 in FIG. 7 and stores the determination result in the first storage device 130 (Step S304).

Subsequently, the image processing unit 144 calculates the processing time taken for the execution of the first image processing and the second image processing in Step S303 and stores the processing time in the first storage device 130 (Step S305).

Subsequently, the image processing unit 144 determines whether the number of processed images is equal to the specific number (Step S306). When the number of processed images is not equal to the specific number, that is, when the number of processed images is less than the specific number, the image processing unit 144 proceeds to Step S312 without executing any particular processing.

On the other hand, when the number of processed images is equal to the specific number, the image processing unit 144 determines whether the total time taken for the execution of the first image processing and the second image processing on the input images acquired by imaging the specific number of media is equal to or less than the total time taken for the conveyance of the specific number of media (Step S307). When the total time taken for the execution of the first image processing and the second image processing is equal to or less than the total time taken for the conveyance of the media, the image processing unit 144 determines that the current pace is acceptable to execute the first image processing and proceeds to Step S312 without executing any particular processing.

On the other hand, when the total time taken for the execution of the first image processing and the second image processing is greater than the total time taken for the conveyance of the media, the notification unit 142 calculates the degree of unnecessariness and the degree of redundancy in substantially the same manner as the processing of Step S115 of FIG. 8 (Step S308).

Subsequently, the notification unit 142 determines whether the degree of unnecessariness or the degree of redundancy meets a predetermined criterion in substantially the same manner as the processing of Step S116 in FIG. 8 (Step S309). When the degree of unnecessariness or the degree of redundancy does not meet the predetermined criterion, the notification unit 142 proceeds to Step S312 without executing any particular processing.

On the other hand, when the degree of unnecessariness or the degree of redundancy meets the predetermined criterion, the notification unit 142 sets a first image processing operation (first image processing) for which the degree of unnecessariness or the degree of redundancy meets the predetermined criterion as a suspended image processing operation (suspended image processing) whose execution is suspended (Step S310).

On the other hand, when the number of processed images is greater than the specific number in Step S302, the image processing unit 144 executes the first image processing operations other than the suspended image processing operation and the second image processing (second image processing operations) among the image processing operations specified to be executed in the profile, on the read input image (Step S311). The image processing unit 144 executes the first image processing other than the suspended image processing and the second image processing in substantially the same manner as the processing of Step S110 in FIG. 7. As described above, when the degree of unnecessariness or the degree of redundancy for the specific number of input images meets the predetermined criterion, the image processing unit 144 executes the second image processing while skipping the first image processing for the input images other than the specific number of input images. When the suspended image processing is not set, the image processing unit 144 outputs an input image on which the first image processing and the second image processing have been executed, in substantially the same manner as the processing of Step S112 in FIG. 7.

Subsequently, the image processing unit 144 determines whether an input image on which the first image processing other than the suspended image processing and the second image processing have not been executed remains (Step S312). When the image processing unit 144 determines that an input image on which the first image processing other than the suspended image processing and the second image processing have not been executed remains, the image processing unit 144 returns to Step S301 and repeats the processing from Step S301.

Accordingly, the image processing unit 144 executes the first image processing on at least the specific number of input images among the multiple input images acquired by the acquisition unit 143 and executes the second image processing on the multiple input images acquired by the acquisition unit 143, that is, all the input images.

On the other hand, when no input image on which the first image processing other than the suspended image processing and the second image processing have not been executed remains, the image processing unit 144 determines whether there is an input image on which the suspended image processing has not been executed (Step S313). When there is no input image on which the suspended image processing has not been executed, the image processing unit 144 ends the process.

On the other hand, when there is an input image on which the suspended image processing has not been executed, the notification unit 142 generates display data of a recommendation screen and outputs the generated display data in substantially the same manner as the processing of Step S104 in FIG. 7 (Step S314). Since imaging a medium is executed asynchronously with executing the first image processing in the present embodiment, the notification unit 142 does not output a recommendation to change the imaging method for a medium with the display data of the recommendation screen.

When there is an input image on which the suspended image processing has not been executed, this indicates that the degree of unnecessariness or the degree of redundancy is determined to meet the predetermined criterion in Step S309. In other words, the notification unit 142 notifies the user of a recommendation to omit the first image processing when the degree of unnecessariness or the degree of redundancy for the specific number of input images meets the predetermined criterion. When the notified first image processing (first image processing operation) is required to be executed with the current settings, the first image processing operation is kept to be executed. When the notified first image processing (first image processing operation) is unnecessary or redundant, a part or all of the first image processing (first image processing operation) is omitted according to a user operation, resulting in the reduction of the processing time of the image reading process. Thus, the image reading apparatus 100 can enhance user convenience.

In particular, the notification unit 142 notifies the user of the recommendation to omit the first image processing after the second image processing is completed for the multiple input images acquired by the acquisition unit 143, that is, all the input images. This allows the user to consider whether to execute the first image processing determined to be unnecessary or redundant with the current settings while considering the time taken for the conveyance of the media and the time taken for the execution of the second image processing, which is required processing, up to the present time. Thus, the image reading apparatus 100 can enhance user convenience.

In the present embodiment, the image reading apparatus 100 can pre-set the specific number for determining whether the first image processing is unnecessary or redundant. Accordingly, the image reading apparatus 100 can prevent the first image processing from being executed on a large number of input images and can accurately determine whether the first image processing is unnecessary or redundant.

Subsequently, the notification unit 142 determines whether an instruction to omit the first image processing has been received, in substantially the same manner as in the processing of Step S105 in FIG. 7 (Step S315).

When receiving an end instruction to end the display of the recommendation screen 900, the notification unit 142 ends the display of the recommendation screen 900 in substantially the same manner as the processing of Step S105 in FIG. 7. The image processing unit 144 executes the suspended image processing on each input image on which the suspended image processing has not been executed (Step S316) and then ends the process. The image processing unit 144 executes the suspended image processing in substantially the same manner as the processing of Step S110 in FIG. 7. The image processing unit 144 outputs the input image on which the suspended image processing has been executed, in substantially the same manner as the processing of Step S112 in FIG. 7.

On the other hand, when the instruction to omit the first image processing is received, the notification unit 142 ends the display of the recommendation screen 900 and sets to omit the suspended image processing specified by the instruction signal, in substantially the same manner as the processing of Step S106 in FIG. 7. The image processing unit 144 executes the suspended image processing operation whose execution is not set to be omitted on each input image on which the suspended image processing has not been executed (Step S317) and then ends the process. The image processing unit 144 executes the suspended image processing whose execution is not set to be omitted, in substantially the same manner as the processing of Step S110 in FIG. 7. The image processing unit 144 does not execute all of the suspended image processing (suspended image processing operation(s)) determined to be unnecessary among the suspended image processing for which the instruction to omit the image processing has been received. Further, the image processing unit 144 does not execute a part of the suspended image processing (suspended image processing operation(s)) determined to be redundant among the suspended image processing for which the instruction to omit the image processing has been received. The image processing unit 144 outputs the input image on which the suspended image processing has been executed, in substantially the same manner as the processing of Step S112 in FIG. 7.

The processing of Steps S305 and S307 may be omitted.

As described above in detail, the image reading apparatus 100 can enhance user convenience even when notifying the user of the recommendation to omit the first image processing after completing the execution of the second image processing on the multiple input images.

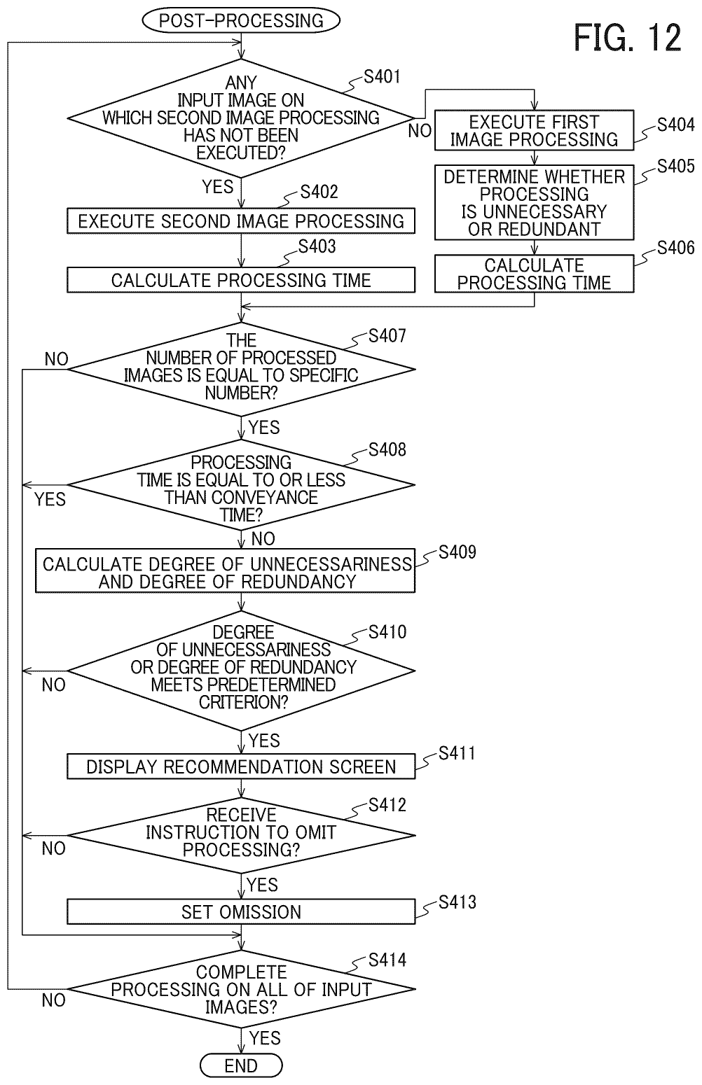

FIG. 12 is a flowchart illustrating an example of post-processing of an image reading apparatus according to still another embodiment.

Referring to FIG. 12, post-processing performed by the image reading apparatus 100 according to the present embodiment is described below. The flow of steps described below is executed by, for example, the first processing circuit 140 in cooperation with one or more of the components of the image reading apparatus 100 according to the program pre-stored in the first storage device 130. The flowchart illustrated in FIG. 12 is executed in parallel with the flowchart illustrated in FIG. 10 instead of the flowchart illustrated in FIGS. 11A and 11B.

First, the image processing unit 144 determines whether an input image on which the second image processing has not been executed remains in the first storage device 130 among the input images acquired in Step S204 in FIG. 10 (Step S401).

When an input image on which the second image processing has not been executed remains, the image processing unit 144 reads the input image on which the second image processing has not been executed from the first storage device 130. The image processing unit 144 executes the second image processing on the read input image in substantially the same manner as the processing of Step S110 in FIG. 7 (Step S402).

Subsequently, the image processing unit 144 calculates the time taken for the execution of the second image processing in Step S402 stores the calculated time in the first storage device 130 (Step S403) and proceeds to Step S407. When the number of input images on which the first image processing has been executed up to the present time exceeds the specific number, the processing of Step S403 may be omitted. In the following description, the number of input images on which the first image processing has been executed up to the present time may be referred to as the number of processed images.

On the other hand, when no input image on which the second image processing has not been executed remains in Step S401, the image processing unit 144 reads an input image on which the second image processing has been executed and the first image processing has not been executed from the first storage device 130. The image processing unit 144 executes the first image processing on the read input image in substantially the same manner as the processing of Step S110 in FIG. 7 (Step S404). When the omission of the first image processing is set in Step S413, which is described later, the image processing unit 144 executes the first image processing that is not set to be omitted on the input image. In other words, the image processing unit 144 does not execute a first image processing operation determined to be unnecessary and a part of a first image processing operation determined to be redundant in the first image processing operations for which the instruction to omit is received. The image processing unit 144 further outputs the input image on which the first image processing and the second image processing have been executed, in substantially the same manner as the processing of Step S112 in FIG. 7.

As described above, the image processing unit 144 executes the second image processing in priority to the first image processing asynchronously with the first image processing, that is, at a timing different from that of the first image processing. Accordingly, the image processing unit 144 preferentially executes the second image processing that is required processing, and executes the first image processing of which the settings may be changed according to the feature of the media when there is a time available during the execution of the second image processing. Thus, the image reading apparatus 100 can execute the image processing efficiently. When the user is notified of the recommendation to omit the first image processing in processing described later, the user can consider whether to execute the first image processing determined to be unnecessary or redundant with the current settings, while considering the time taken for the conveyance of the media and the time taken for the execution of the second image processing, which is required processing, up to the present time. Thus, the image reading apparatus 100 can enhance user convenience.

Subsequently, the image processing unit 144 determines whether the executed first image processing is unnecessary or redundant in substantially the same manner as the processing of Step S111 in FIG. 7 and stores the determination result in the first storage device 130 (Step S405). When the number of processed images is greater than the specific number, the processing of Step S405 may be omitted.

Subsequently, the image processing unit 144 calculates the time taken for the execution of the first image processing in Step S404 stores the calculated time in the first storage device 130 (Step S406) and proceeds to Step S407. When the number of processed images is greater than the specific number, the processing of Step S406 may be omitted.

Subsequently, the image processing unit 144 determines whether the number of processed images is equal to the specific number (Step S407). When the number of processed images is less than or greater than the specific number, the image processing unit 144 proceeds to Step S414 without executing any particular processing.

On the other hand, when the number of processed images is equal to the specific number, the image processing unit 144 determines whether the total time taken for the execution of the first image processing and the second image processing on the input images acquired by imaging the specific number of media is equal to or less than the total time taken for the conveyance of the specific number of media (Step S408). The image processing unit 144 calculates the total time taken for the execution of the second image processing on the input images acquired by imaging the specific number of media by multiplying the specific number by the average value of the time taken for the execution of the second image processing calculated up to the present time in Step S403. The image processing unit 144 further calculates the total time taken for the conveyance of the specific number of media by multiplying the average value of the time taken for the conveyance of the media up to the present time by the specific number. When the total time taken for the execution of the first image processing and the second image processing is equal to or less than the total time taken for the conveyance of the media, the image processing unit 144 determines that the current pace is acceptable to execute the first image processing and proceeds to Step S414 without executing any particular processing.

On the other hand, when the total time taken for the execution of the first image processing and the second image processing is greater than the total time taken for the conveyance of the media, the notification unit 142 calculates the degree of unnecessariness and the degree of redundancy in substantially the same manner as the processing of Step S115 of FIG. 8 (Step S409).

Subsequently, the notification unit 142 determines whether the degree of unnecessariness or the degree of redundancy meets a predetermined criterion in substantially the same manner as the processing of Step S116 in FIG. 8 (Step S410). When the degree of unnecessariness or the degree of redundancy does not meet the predetermined criterion, the notification unit 142 proceeds to Step S414 without executing any particular processing.

On the other hand, when the degree of unnecessariness or the degree of redundancy meets the predetermined criterion, the notification unit 142 generates display data of a recommendation screen and outputs the generated display data in substantially the same manner as the processing of Step S104 in FIG. 7 (Step S411). Since imaging each medium is executed asynchronously with executing the first image processing in the present embodiment, the notification unit 142 does not output a recommendation to change the imaging method for a medium with the display data of the recommendation screen.

As described above, the notification unit 142 notifies the user that the first image processing is recommended to be omitted when the degree of unnecessariness or the degree of redundancy for the specific number of input images meets the predetermined criterion. When the notified first image processing (first image processing operation) is required to be executed with the current settings, the notified first image processing (first image processing operation) is kept to be executed. When the notified first image processing (first image processing operation) is unnecessary or redundant, a part or all of the first image processing (first image processing operation) is omitted according to a user operation, resulting in the reduction of the processing time of the image reading process. Thus, the image reading apparatus 100 can enhance user convenience.

In particular, the notification unit 142 executes the second image processing on the multiple input images acquired by the acquisition unit 143 asynchronously with the first image processing, that is, at a timing different from that of the first image processing. When the degree of unnecessariness or the degree of redundancy for the specific number of input images meets a predetermined criterion at the time of the completion of the first image processing on the specific number of input images, the notification unit 142 notifies the user of the recommendation to omit the first image processing. Accordingly, the image reading apparatus 100 can determine whether the first image processing is unnecessary or redundant after executing the first image processing for the number of input images that is suitable for determining whether the first image processing is unnecessary or redundant, while executing the first image processing asynchronously with the second image processing. As a result, the image reading apparatus 100 can determine whether the first image processing is unnecessary or redundant at an appropriate timing while efficiently executing each type of image processing.

The notification unit 142 notifies the user of the recommendation to omit the first image processing regardless of whether the second image processing on the multiple input images acquired by the acquisition unit 143 is completed. Accordingly, the image reading apparatus 100 can determine whether the first image processing is unnecessary or redundant at an appropriate timing while efficiently executing each type of image processing.

In the present embodiment, the image reading apparatus 100 can pre-set the specific number for determining whether the first image processing is unnecessary or redundant.

Accordingly, the image reading apparatus 100 can prevent the first image processing from being executed for a large number of input images and can accurately determine whether the first image processing is unnecessary or redundant.

Subsequently, the notification unit 142 determines whether an instruction to omit the first image processing has been received, in substantially the same manner as in the processing of Step S105 in FIG. 7 (Step S412). When receiving an end instruction to end the display of the recommendation screen 900, the notification unit 142 ends the display of the recommendation screen 900 in substantially the same manner as the processing of Step S105 in FIG. 7 and proceeds to Step S414.

On the other hand, when the instruction to omit the first image processing is received, the notification unit 142 ends the display of the recommendation screen 900 in substantially the same manner as the processing of Step S106 in FIG. 7. Then, the notification unit 142 sets the omission of each first image processing operation specified by the instruction signal (Step S413).

Subsequently, the image processing unit 144 determines whether an input image on which the second image processing and the first image processing excluding one or more first image processing operations determined to be unnecessary have not been executed remains (Step S414). When an input image on which the second image processing and the first image processing excluding one or more first image processing operations determined to be unnecessary have not been executed remains, the image processing unit 144 returns to Step S401 and repeats the processing from Step S401.

Accordingly, the image processing unit 144 executes the first image processing on at least the specific number of input images among the multiple input images acquired by the acquisition unit 143 and executes the second image processing on the multiple input images acquired by the acquisition unit 143, that is, all the input images. On the other hand, when there is no input image on which the second image processing and the first image processing excluding one or more first image processing operations determined to be unnecessary have not been executed, the image processing unit 144 ends the process.

As described in Step S115 of FIG. 7, the image processing unit 144 may calculate the degree of unnecessariness or the degree of redundancy based on the feature information of the input image instead of the execution result of the first image processing in Step S409. In other words, the image processing unit 144 may calculate the degree of unnecessariness or the degree of redundancy based on feature information of input images regardless of whether the first image processing has been executed on the input images. In this case, for example, the image processing unit 144 executes the second image processing and detects the feature information of the input image in Step S402. In Step S407, the image processing unit 144 determines whether the number of input images for which the feature information has been detected up to the present time is equal to the specific number. When the number of input images for which the feature information has been detected up to the present time is the specific number, the image processing unit 144 proceeds to Step S408.

Accordingly, the image processing unit 144 can determine whether the first image processing is unnecessary or redundant without executing the first image processing on the specific number of input images. As a result, the image processing unit 144 may not execute the first image processing on the specific number of input images, and this can reduce the time taken for the media reading.

The image processing unit 144 may execute the first image processing as a task different from the second image processing. The processing of steps S403, S406, and S408 may be omitted.

As described above in detail, even when the image reading apparatus 100 notifies the user of the recommendation to omit the first image processing while executing the second image processing asynchronously with the first image processing, the image reading apparatus 100 can enhance user convenience.

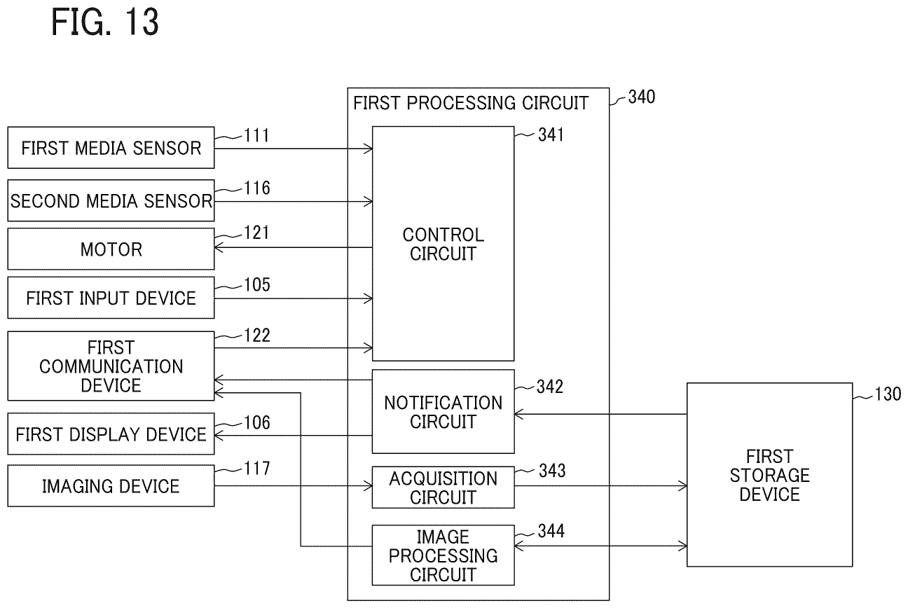

FIG. 13 is a schematic block diagram illustrating a configuration of a first processing circuit 340 in an image reading apparatus according to another embodiment.

The first processing circuit 340 is used instead of the first processing circuit 140 and performs an image reading process. The first processing circuit 340 includes a control circuit 341, a notification circuit 342, an acquisition circuit 343, and an image processing circuit 344.

The control circuit 341 is an example of a control unit and functions like the control unit 141. The control circuit 341 receives the operation signal from the first input device 105 or the first communication device 122, the first media signal from the first media sensor 111, and the second media signal from the second media sensor 116. The control circuit 341 controls the motor 121 based on the received signals.

The notification circuit 342 is an example of a notification unit and functions like the notification unit 142. The notification circuit 342 reads the degree of unnecessariness or the degree of redundancy from the first storage device 130, generates display data of a recommendation screen based the read information, and outputs the display data to the first display device 106 or the first communication device 122.

The acquisition circuit 343 is an example of an acquisition unit and functions like the acquisition unit 143. The acquisition circuit 343 acquires an input image from the imaging device 117 and stores the acquired input image in the first storage device 130.

The image processing circuit 344 is an example of an image processing unit and functions like the image processing unit 144. The image processing circuit 344 reads an input image from the first storage device 130, executes the first image processing and the second image processing, calculates the degree of unnecessariness or the degree of redundancy, and stores the degree of unnecessariness or the degree of redundancy in the first storage device 130. The image processing circuit 344 outputs the input image to the first communication device 122.

As described above in detail, the image reading apparatus using the first processing circuit 340 also can enhance user convenience.

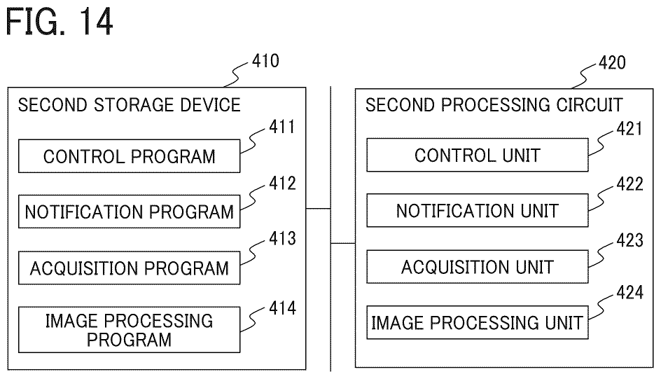

FIG. 14 is a schematic block diagram illustrating a configuration of a second storage device 410 and a second processing circuit 420 in an information processing apparatus according to still another embodiment.

As illustrated in FIG. 14, the second storage device 410 stores a control program 411, a notification program 412, an acquisition program 413, and an image processing program 414. These programs are functional modules implemented by software operating on a processor. The second processing circuit 420 reads the programs stored in the first storage device 130 and operates according to the read programs, thereby functioning as a control unit 421, a notification unit 422, an acquisition unit 423, and an image processing unit 424.

The control unit 421, the notification unit 422, the acquisition unit 423, and the image processing unit 424 have the same or substantially the same functions as the control unit 141, the notification unit 142, the acquisition unit 143, and the image processing unit 144 of the image reading apparatus 100, respectively. The second storage device 410 stores the data stored by the first storage device 130. The processing of Steps S101 to S106, S108 to S112, and S114 to S118 in the image reading process of FIGS. 7 and 8, the processing of Step S201, Steps S203 to S204, and Step S206 in the image reading process of FIG. 10, the processing of Steps S301 to S317 in the post-processing of FIGS. 11A and 11B, and the processing of Steps S401 to S414 in the post-processing of FIG. 12 are executed by the control unit 421, the notification unit 422, the acquisition unit 423, and the image processing unit 424.

In Steps S101 and S201, the control unit 421 receives an operation signal indicating an instruction to read media from the second input device 201 from the second input device 201. The operation signal is output when the user inputs the instruction using the second input device 201. The control unit 421 transmits the received operation signal to the image reading apparatus 100 via the second communication device 203.

In Steps S104, S314, and S414, notification unit 422 outputs display data of a recommendation screen by displaying the recommendation screen on the second display device 202.

In Steps S105, S315, and S412, the notification unit 142 receives an instruction signal from the second input device 201 and receives an instruction to omit the first image processing or change the imaging method for a medium accordingly.

In Steps S106, S317, and S413, the notification unit 142 sets to omit the first image processing or change the imaging method for a medium by changing the setting information stored in the second storage device 410.

In Steps S108 and S203, the control unit 421 transmits a request signal requesting to drive the motor 121 to the image reading apparatus 100 via the second communication device 203. The control unit 141 of the image reading apparatus 100 receives the request signal from the information processing apparatus 200 via the first communication device 122 and drives the motor 121 according to the received request signal. Thus, the control unit 421 feeds and conveys the media.

In Steps S109 and S204, the acquisition unit 143 transmits the input image to the information processing apparatus 200 via the first communication device 122. The acquisition unit 423 acquires the input image by receiving the input image from the image reading apparatus 100 via the second communication device 203 and stores in the second storage device 410.

In Steps S112, S303, S311, S316, S317, and S404, the image processing unit 424 outputs the input image by displaying the input image on the second display device 202.

In Steps S114 and S206, the control unit 421 transmits a request signal requesting to stop the motor 121 to the image reading apparatus 100 via the second communication device 203. The control unit 141 of the image reading apparatus 100 receives the request signal from the information processing apparatus 200 via the first communication device 122 and stops the motor 121 according to the received request signal. Thus, the control unit 421 stops the image generation process performed by the image reading apparatus 100 that has generated the input images.

In Step S301, the image processing unit 144 reads an input image from the second storage device 210.

A part of the processing steps executed by each unit of the information processing apparatus may be executed by the corresponding unit of the image reading apparatus.

As described above in detail, the image processing system can enhance user convenience also when the information processing apparatus performs a part of the image reading process or a part of the post-processing.

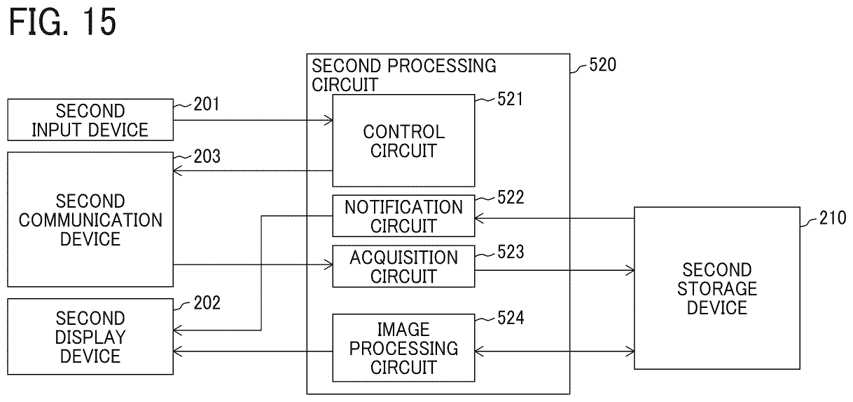

FIG. 15 is a schematic block diagram illustrating a configuration of a second processing circuit 520 in an information processing apparatus according to still another embodiment.

The second processing circuit 520 is used instead of the second processing circuit 420 and performs an image reading process. The second processing circuit 520 includes a control circuit 521, a notification circuit 522, an acquisition circuit 523, and an image processing circuit 524.

The control circuit 521 is an example of a control unit and functions like the control unit 421. The control circuit 521 receives an operation signal from the second input device 201 and outputs the received operation signal to the second communication device 203.

The notification circuit 522 is an example of a notification unit and functions like the notification unit 422. The notification circuit 522 reads the degree of unnecessariness or the degree of redundancy from the second storage device 210, generates display data of a recommendation screen based the read information, and outputs the display data to the second display device 202.

The acquisition circuit 523 is an example of the acquisition unit and functions like the acquisition unit 423. The acquisition circuit 523 receives the input image from the second communication device 203 and stores the input image in the second storage device 210.

The image processing circuit 524 is an example of an image processing unit and functions like the image processing unit 424. The image processing circuit 524 reads an input image from the second storage device 210, executes the first image processing and the second image processing, calculates the degree of unnecessariness or the degree of redundancy, and stores the degree of unnecessariness or the degree of redundancy in the second storage device 210. The image processing circuit 524 further outputs the input image to the second display device 202.

As described above in detail, the information processing apparatus using the second processing circuit 520 also can enhance user convenience.

Although several embodiments of the present disclosure have been described above, the embodiments are not limited thereto. For example, when the degree of unnecessariness or redundancy meets a predetermined criterion, the notification unit 142 may set to omit the first image processing or change the imaging method for a medium without notifying the user of a recommendation to omit the first image processing or change the imaging method for a medium.

Further, the image reading apparatus may have a so-called U-turn path, sequentially feed and convey the media placed on the media tray from the top, and sequentially discharge the media to the ejection tray.

Enhancing user convenience has been required in image processing apparatuses in the related art.

According to one or more aspects of the present disclosure, an image processing apparatus, an image processing system, an image processing method, and a control program can enhance user convenience.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image processing apparatus, comprising circuitry configured to:
acquire a plurality of input images by imaging media;
execute image processing on a specific number of input images among the plurality of input images; and
output a recommendation to omit the image processing or change an imaging method for a medium when a degree of unnecessariness or redundancy of the image processing for the specific number of input images meets a predetermined criterion.

2. The image processing apparatus of claim 1, wherein
the circuitry is configured to output the recommendation to omit the image processing or change the imaging method for a medium when a medium is newly read without changing settings for imaging processing or the image processing after the specific number of input images are generated in an image reading apparatus.

3. The image processing apparatus of claim 1, wherein
the circuitry is configured to acquire the specific number of input images by imaging corresponding media that are collectively placed on a media tray and sequentially conveyed to be imaged in an image reading apparatus.

4. The image processing apparatus of claim 1, wherein
the circuitry is configured to:
execute additional image processing on the plurality of input images, wherein the additional image processing is different from the image processing; and
output the recommendation to omit the image processing after the additional image processing is completed.

5. The image processing apparatus of claim 1, wherein
the circuitry is configured to execute additional image processing on the plurality of input images in priority to and asynchronously with the image processing, wherein the additional image processing is different from the image processing.

6. The image processing apparatus of claim 5, wherein
the circuitry is configured to output the recommendation to omit the image processing regardless of whether the additional image processing on the plurality of input image is completed.

7. The image processing apparatus of claim 1, wherein
the circuitry is further configured to calculate the degree of unnecessariness or redundancy of the image processing based on feature information of the plurality of input images regardless of whether the image processing has been executed on the plurality of input images.

8. An image processing system comprising:
an image reading apparatus including first circuitry; and
an information processing apparatus including second circuitry,
the first circuitry and second circuitry being configured to operate in cooperation to:
acquire a plurality of input images by imaging media;
execute image processing on a specific number of input images among the plurality of input images; and
output a recommendation to omit the image processing or change an imaging method for a medium when a degree of unnecessariness or redundancy of the image processing for the specific number of input images meets a predetermined criterion.

9. An image processing method, comprising:
acquiring a plurality of input images by imaging media;
executing image processing on a specific number of input images among the plurality of input images; and
outputting a recommendation to omit the image processing or change an imaging method for a medium when a degree of unnecessariness or redundancy of the image processing for the specific number of input images meets a predetermined criterion.
